(19) United States
(12) Patent Application Publication
(10) Pub. No.: US 2008/0088925 A1
(43) Pub. Date: Apr. 17, 2008

(54) Antireflection Film, Polarizing Plate And Image Display Utilizing The Same

(75) Inventors: Hiroyuki Yoneyama, Kanagawa (JP); Akira Ikeda, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/660,045

(22) PCT Filed: Aug. 2, 2005
(86) PCT No.: PCT/JP05/14485

§ 371 Date: Feb. 12, 2007

(30) Foreign Application Priority Data
Aug. 12, 2004 (JP) 2004-235198

(51) Int. Cl. G02B 5/30

(52) U.S. Cl. 359/492

(57) ABSTRACT

An antireflection film is provided and includes at least one layer containing fine pores. When a surface portion of the antireflection film comes into contact with water for 15 minutes and then the water is wiped away, the surface portion has a chromaticity change ΔE of 0.45 or less, the chromaticity change ΔE being a chromaticity change in a CIE1976 L*a*b* color space and measured under a standard light source D65.

### TECHNICAL FIELD

The present invention relates to an antireflection film, polarizing plate and image display.

### BACKGROUND ART

An antireflection film is generally employed in a display such as a cathode ray tube display (CRT), a plasma display panel (PDP), an electroluminescent display (ELD) or a liquid crystal display apparatus (LCD), on an outermost surface of such display in order to reduce a reflectance by principle of an optical interference, thereby preventing a reduction in a display contrast by a reflection of an external light or a reflection of an external image.

Such antireflection film can be prepared by forming a low refractive index layer of an appropriate thickness on an outermost surface of a substrate, and suitably forming a high refractive index layer, a medium refractive index layer, a hard coat layer and the like eventually between the substrate and the low refractive index layer. The low refractive index layer is required to have a refractive index as low as possible in order to realize a low reflectance. Also the antireflection film, being employed in the outermost surface, is expected to have a function as a protective film for the display apparatus, such as little deposition of dusts and smear and a high scratch resistance.

A reduction in the refractive index of a material can be realized by an introduction of a fluorine atom-containing organic group into a binder or by reduction in a density (introduction of cavities). In case of introducing a fluorine atom-containing organic group into the binder, a loss in an agglomerating power of the binder itself is caused and has to be compensated by introducing a necessary coupling group, whereby the reduction of the refractive index has a certain limit in practice and it is difficult to realize a refractive index of 1.40 or lower. On the other hand, the method of introducing micro cavities into the low refractive index layer for reducing the refractive index can achieve a refractive index lower than 1.40, but is associated with drawbacks of a low film strength and an easy penetration of smears such as fingerprints or oil.

For example, JP-A Nos. 6-3501, 9-222502 and 9-222503 describe attempts for reducing the refractive index by forming micro pores in the binder. Also a patent literature 4 describes an attempt to lower the refractive index by utilizing porous silica. These attempts are insufficient in practice in the film strength or in fingerprint smear.

Also JP-A Nos. 7-48527, 2001-233611, 2002-79616, 2002-317152, 2003-202406 and 2003-292831 describes an antireflection film containing hollow silica particles in a low refractive index layer.

An antireflection film containing hollow silica particles in a low refractive index layer certainly shows a scratch resistance or a resistance to deposition of a smear such as fingerprints in comparison with prior technologies, but is found to show drawbacks, by a saponification process at the preparation of a polarizing plate, that the film is destructed or a trace remains when a water drop is newly attached. As such antireflection film, being used on the outermost surface of a display, may be exposed to a water drop sticking in the daily use, and an improvement is essential in order to obtain a practical durability.

### DISCLOSURE OF THE INVENTION

An object of a non-limiting, illustrative embodiment of the present invention is to provide an antireflection film showing a low reflectance, a suppressed glare, a reduced trace of attached water drop and an excellent smear resistance, and also to provide a polarizing plate and an image display utilizing such antireflection film.

Based on intensive investigations, the present inventors have found that the aforementioned objects can be attained by an antireflection film of following configurations, and a polarizing plate and an image display utilizing the same:

(1) An antireflection film comprising at least one layer comprising fine pores, wherein when a surface portion of the antireflection film comes into contact with water for 15 minutes and then the water is wiped away, the surface portion has a chromaticity change ΔE of 0.45 or less, the chromaticity change ΔE being a chromaticity change in a CIE1976 L*a*b* color space and measured under a standard light source D65.

(2) An antireflection film comprising at least one low refractive index layer having a refractive index of 1.40 or less, wherein when a surface portion of the antireflection film comes into contact with water for 15 minutes and then the water is wiped away, the surface portion has a chromaticity change ΔE of 0.45 or less, the chromaticity change ΔE being a chromaticity change in a CIE1976 L*a*b* color space and measured under a standard light source D65.

(3) An antireflection film as described in (1) or (2), which is subjected to an alkali saponification process.

(4) An antireflection film as described in any one of (1) to (3), wherein the at least one layer comprises inorganic fine particles having at least one of a porous structure and a hollow structure.

(5) An antireflection film as described in (4), wherein the inorganic fine particles have an adsorbed water amount of 6.1 weight % or less and have a particle size of 20 to 100 nm.

(6) An antireflection film as described in any one of (2) to (5), wherein the low refractive index layer comprises a component having one of a fluorinated alkyl portion and a dialkylsiloxane portion.

(7) An antireflection film as described in any one of (4) to (6), wherein the inorganic fine particles are hollow silica fine particles, and the hollow silica fine particles have a refractive index of 1.40 or less.

(8) An antireflection film as described in (7), wherein the hollow silica fine particles have a particle size of 45 to 80 nm and a refractive index of 1.30 or less.

(9) A polarizing plate comprising: a polarizer; and a protective film, wherein the protective film comprises an antireflection film as described in any one of (1) to (8).

(10) An image display comprising at least one of an antireflection film as described in any one of (1) to (8) and a polarizing plate as described in (9).

The antireflection film of the present invention has a low reflectance, a suppressed glare, little trace of attached water drop and an excellent smear resistance. Also the polarizing plate or the image display utilizing the antireflection film of the invention shows a reduced reflection or an external light or a background, thus showing an excellent visibility.

### DETAILED DESCRIPTION OF THE INVENTION

In the following, exemplary embodiments of the present invention will be clarified in further details. In the present specification, in case a physical property or a characteristic property is represented by a numerical value, a description “(number 1) to (number 2)” means “equal to or larger than (number 1) and equal to or smaller than (number 2)”.

(Evaluation of Water Trace)

The antireflection film of the invention is characterized in that a surface portion on a side thereof having a low refractive index layer (or a layer having fine pores), contacted with water for 15 minutes and then wiped, has a chromaticity change ΔE equal to or less than 0.45. The chromaticity change ΔE is a chromaticity change in a CIE1976 L*a*b* color space and measured under a standard light source D65. More specifically, the water trace of the surface portion was evaluated in a following method.

An outermost surface of an antireflection film of a film, a polarizing plate or an image display was positioned horizontally. After it was let to stand for 30 minutes in a condition of 25° C. and 55% RH, 2.0 ml of ion-exchanged water were dropped over about 2 seconds with a pipette (manufactured by Eppendorf AG). The water drop was spread to a circular shape of a diameter of about 1.5 to 2.5 cm, though an ease of spreading varies depending on a surface property of the antireflection film. After a standing for 15 minutes, the water drop was wiped off with Bemcot (manufactured by Asahi Kasei Corp.). A reflective spectrum of the antireflection film was measured before and after the dropping of the water drop. The measurement was conducted with a UV/V is Spectrophotometer Model V-550 manufactured by JASCO Inc. and a chromaticity change ΔE in a CIE1976 L*a*b; color space under a standard light source D65 was determined.

ΔE is preferably as small as possible, and is 0.45 or less in the invention, more preferably 0.35 or less, further preferably 0.20 or less, and most preferably 0.10 or less. In subjective tests by plural testing persons, the water trace could be sufficiently recognized at ΔE of 0.60 or higher and was recognized as a failure with ΔE exceeding 1.0.

(Introduction of Pores into Layer Constituting Antireflection Film)

In the invention, it is preferable, for sufficiently reducing the refractive index principally of a low refractive index layer, to introduce fine pores into the layer and a method for this purpose, though not particularly restricted, can be a method of generating bubbles in the layer and curing the layer to fix the bubbles, a method of utilizing voids formed by a superposition of particles introduced into the layer, a method of introducing porous fine particles into the layer, or a method of introducing hollow fine particles. In consideration of stability in the manufacture, there are preferred a method of introducing porous fine particles into the layer, and a method of introducing hollow fine particles.

In hollow fine particles, a pore rate x is represented by a following equation (1):
x=(rᵢ/rₒ)³×100(%) (1)

wherein rᵢ represents a radium of a pore in a particle, and rₒ represents a radium of an outer shell of a particle.

The pore rate in the hollow fine particles is preferably 10-60%, more preferably 20-60% and most preferably 30-60%. A pore rate of the hollow fine particles within the aforementioned range is preferably in obtaining a low refractive index and maintaining a durability of the particles.

(Method for Preparing Pore-Containing Fine Particles)

Such pore-containing fine particles (porous or hollow fine particles) to be employed are not restricted in a structure or a type, but preferably are porous inorganic oxide fine particles, and most preferably a hollow organic polymer latex or hollow inorganic oxide fine particles. The inorganic oxide fine particles are preferably fine particles principally constituted of aluminum oxide, silicon oxide or tin oxide.

A preferred producing method for the hollow fine particles is constituted of following steps: a first step of forming a core particle that can be eliminated by a post-process, a second step of forming a shell layer, a third step of dissolving the core particle, and if necessary a fourth step of forming an additional shell phase. More specifically, the hollow particles can be prepared according to a producing method for hollow silica fine particles described for example in JP-A No. 2001-233611.

A preferred producing method for the porous particles is a method of preparing, in a first step, porous core particles by controlling a level of a hydrolysis or a condensation of an alkoxide, a type and an amount of a co-existing substance, and forming a shell layer on the surface in a second step. More specifically, the preparation of the porous particles can be executed by methods described for example in JP-A Nos. 2003-327424, 2003-335515, 2003-226516 and 2003-238140.

In the invention, a reduction in an adsorbed water amount in the inorganic fine particles to be explained later is preferable, and can be controlled for example by a change in the particle size, a change in the shell thickness or a hydrothermal process condition. Also a reduction in an adsorbed water amount can be realized by calcining the particles.

(Measurement of Adsorbed Water Amount in Pore-Containing Fine Particles)

In the present invention, an adsorbed water amount in pore-containing fine particles can be measured by a following measuring method. A powder of particles was dried for 1 hour with a rotary pump under a condition of 20° C. and about 1 hPa, and was then let to stand for 1 hour under a condition of 20° C. and 55% RH. A sample after drying of about 10 mg was weighed in a platinum cell by DTG-50 manufactured by Shimadzu Ltd., and the temperature was elevated from 20° C. to 950° C. with a heating speed of 20° C./min. An adsorbed water amount was calculated by a following equation as a weight decrease percentage when the temperature was elevated to 200° C.:
adsorbed water amount(%)=100×(W20−W200)/W200
wherein W20 is an initial weight after the start of temperature elevation, and W200 is a weight at a temperature elevation to 200° C.

In case the particles are in a dispersion liquid, the adsorbed water amount can be measured by distilling of a solvent in an evaporator (25° C., a reduced pressure of 10 hPa), then grinding a residue into a powder in an agate mortar, and then executing the aforementioned method.

In the present invention, the adsorbed water amount is preferably 6.1 weight % or less, more preferably 5.5 weight % or less and most preferably 5.0 weight % or less.

In case a layer contains particles of plural kinds different in particle size or preparing condition, an adsorbed water amount of 6.1 weight % or less is required in at least a kind of such particles. However, the particles having an adsorbed water amount of 6.1 weight % or less preferably represent 30 weight % or higher in all the particles, more preferably 50 weight % or higher and further preferably 70 weight % or higher.

(Measurement of Particle Size of Pore-Containing Fine Particles)

A particle size of the pore-containing fine particles in the invention was measured by observing particles under a transmission electron microscope, and calculating an average circle-corresponding diameter of 1,000 particles. The diameter is preferably 20 to 100 nm, more preferably 35 to 100 nm and most preferably 45 to 80 nm. An excessively small particle size undesirably results in an increase in the refractive index or an increase in the absorbed water amount, while an excessively large particle size undesirably results in a large scattering in a coated film when an antireflection film is constructed.

In the present invention, the pore-containing fine particles may have a size distribution, of which a variation coefficient is preferably 60 to 5%, more preferably 50 to 10%. It is also possible to employ particles of two or more kinds, different in an average particle size, as a mixture.

(Measurement of Refractive Index of Pore-Containing Fine Particles)

The pore-containing fine particles advantageously employable in the invention preferably has a refractive index of 1.15 to 1.40, more preferably 1.15 to 1.35 and most preferably 1.18 to 1.30. A refractive index of the particles can be measured by a following method.

(1) Preparation of Solution of Matrix Constituting Component

A mixed solution of 55 g of tetraethoxysilane (TEOS) (SiO₂ concentration: 28 weight %), 200 g of ethanol, 1.4 g of concentrated nitric acid and 34 g of water was agitated for 5 hours at the room temperature. An amount of ethanol was so regulated as to obtain a concentration, converted into SiO₂, of 5 weight % thereby obtaining a solution (M-1) containing a matrix constituting component.

(2) Preparation of Coated Film

Coating liquids for refractive index measurement were prepared by mixing the matrix constituting component solution (M-1) and pore-containing fine particles so as to obtain an oxide-converted weight ratio (matrix (SiO₂): pore-containing fine particles (MOₓ+SiO₂)) of 100:0, 90:10, 80:20, 60:40, 50:50 and 25:75. Inorganic compounds other than silica are represented by MOₓ. Each coating liquid was spin coated at 300 rpm on a silicon wafer maintained at a surface temperature of 50° C., then heated for 30 minutes at 160° C., and the formed film for refractive index measurement was subjected to a refractive index measurement with an ellipsometer.

(3) Calculation of Refractive Index

Then the obtained refractive index was plotted as a function of the particle mixing ratio (particles: (MOₓ+SiO₂)/(particles: (MOₓ+SiO₂)+matrix: SiO₂)), and a refractive index when the particles represented 100% was determined by an extrapolation. As an excessively high proportion of the pore-containing fine particles may form voids in the film for measurement an may reduce the refractive index of the film, data of a sample with a high proportion of the pore-containing fine particles, not matching the dependence on the amount of the particles, were excluded.

(Surface Treating Method for Pore-Containing Fine Particles)

In the following there will be explained a method for treating the surface of the pore-containing fine particles (porous or hollow inorganic fine particles). In order to improve a dispersibility in a binder for the low refractive index layer, containing a fluorinated alkyl portion and/or a dimethylsiloxane portion to be explained later, the surface of the inorganic fine particles is preferably treated with an hydrolysate of an organosilane represented by a following formula (I) and/or a partial condensate thereof, and more preferably an acid catalyst and/or a metal chelate compound is employed at the treatment.

(Organosilane Compound)

Now a detailed explanation will be given on an organosilane compound to be employed in the invention.
(R¹⁰)ₘ—Si(X)₄₋ₘ formula (I)

In the formula (I), R¹⁰ represents a substituted or non-substituted alkyl group, or a substituted or non-substituted aryl group. The alkyl group can be, for example, a methyl group, an ethyl group, a propyl group, an isopropyl group, a hexyl group, a t-butyl group, a sec-butyl group, a hexyl group, a decyl group or a hexadecyl group. The alkyl group preferably has 1 to 30 carbon atoms, more preferably 1 to 16 carbon atoms and particularly preferably 1 to 6 carbon atoms. The aryl group can be a phenyl group or a naphthyl group, and preferably a phenyl group.

X represents a hydroxyl group or a hydrolysable group. The hydrolysable group can be, for example, an alkoxy group (preferably an alkoxy group with 1 to 5 carbon atoms, such as methoxy group or an ethoxy group), a halogen atom (such as Cl, Br or I), or an R²COO group (R² being preferably a hydrogen atom or an alkyl group with 1 to 5 carbon atoms, such as CH₃COO or C₂H₅COO), preferably an alkoxy group and particularly preferably a methoxy group or an ethoxy group.

m represents an integer of 1 to 3. In case R¹⁰ or X is present in plural units, plural R¹⁰ or X may be mutually same or different. m is preferably 1 or 2, and particularly preferably 1.

A substituent contained in R¹⁰ is not particularly restricted, and can be a halogen atom (such as fluorine atom, chlorine atom or bromine atom), a hydroxyl group, a mercapto group, a carboxyl group, an epoxy group, an alkyl group (such as a methyl group, an ethyl group, an i-propyl group, a propyl group, or a t-butyl group), an aryl group (such as a phenyl group or a naphthyl group), an aromatic heterocyclic group (such as a furyl group, a pirazolyl group or a pyridyl group), an alkoxy group (such as a methoxy group, an ethoxy group, an i-propoxy group or a hexyloxy group), an aryloxy group (such as a phenoxy group), an alkylthio group (such as a methylthio group or an ethylthio group), an arylthio group (such as a phenylthio group), an alkenyl group (such as a vinyl group, or a 1-propenyl group), an acyloxy group (such as an acetoxy group, an acryloyloxy group or a methacryloyloxy group), an alkoxycarbonyl group (such as a methoxycarbonyl group or an ethoxycarbonyl group), an aryloxycarbonyl group (such as a phenoxycarbonyl group), a carbamoyl group (such as a carbamoyl group, an N-methylcarbamoyl group, an N,N-dimethylcarbamoyl group or an N-methyl-N-octylcarbamoyl group), or an acylamino group (such as an acetylamino group, a benzoylamino group, an acrylamino group or a methacrylamino group), and such substituent may be further substituted. In the present specification, a group substituting a hydrogen atom is a single atom, it is considered also as a substituent for the purpose of convenience.

(Vinylic Polymerizable Group-Containing Organosilane Compound)

In case R¹⁰ is present in plural units, at least one thereof is preferably a substituted alkyl group or a substituted aryl group. Among these, such substituted alkyl group or substituted aryl group preferably further has a vinylic polymerizable group, and, in such case, the compound represented by the formula (I) can be represented as an organosilane compound having a vinylic polymerizable substituent, represented by a following formula (II):

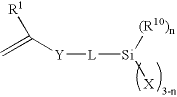

In the formula (II), R¹ represents a hydrogen atom, a methyl group, a methoxy group, an alkoxycarbonyl group, a cyano group, a fluorine atom or a chlorine atom. The alkoxycarbonyl group can be a methoxycarbonyl group or an ethoxycarbonyl group. R¹ is preferably a hydrogen atom, a methyl group, a methoxy group, a methoxycarbonyl group, a cyano group, a fluorine atom or a chlorine atom, more preferably a hydrogen atom, a methyl group, a methoxycarbonyl group, a fluorine atom or a chlorine atom, and particularly preferably a hydrogen atom or a methyl group.

Y represents a single bond, an ester group, an amide group, an ether group or an urea group, preferably a single bond, an ester group, or an amide group, further preferably a single bond or an ester group, and particularly preferably an ester group.

L is a divalent connecting group, more specifically a substituted or non-substituted alkylene group, a substituted or non-substituted arylene group, a substituted or non-substituted alkylene group internally having a connecting group (such as an ether group, an ester group or an amide group), or a substituted or non-substituted arylene group internally having a connecting group, preferably a substituted or non-substituted alkylene group with 2 to 10 carbon atoms, a substituted or non-substituted arylene group with 6 to 20 carbon atoms, or an alkylene group with 3 to 10 carbon atoms internally having a connecting group, further preferably a non-substituted alkylene group, a non-substituted arylene group, or an alkylene group internally having an ether connecting group or an ester connecting group, and particularly preferably a non-substituted alkylene group or an alkylene group internally having an ether connecting group or an ester connecting group. The substituent can be a halogen atom, a hydroxyl group, a mercapto group, a carboxyl group, an epoxy group, an alkyl group or an aryl group, and such substituent may be further substituted.

n represents 0 or 1. In case X is present in plural units, the plural X may be mutually same or different. n is preferably 0.

R¹⁰ has a same meaning as R¹⁰ in the formula (I), and is preferably a substituted or non-substituted aryl group, more preferably a non-substituted alkyl group or a non-substituted aryl group.

X has a same meaning as X in the formula (I), and is preferably a halogen, a hydroxyl group, a non-substituted alkoxy group, more preferably a halogen, a hydroxyl group or a non-substituted alkoxy group, further preferably a chlorine atom, a hydroxyl group, or a non-substituted alkoxy group with 1 to 6 carbon atoms, further preferably a hydroxyl group or an alkoxy group with 1 to 3 carbon atoms, and particularly preferably a methoxy group.

(Fluorine-Containing Group-Containing Organosilane Compound)

An organosilane compound to be employed in the present invention is preferably a compound represented by a following formula (III).
(Rf-L₁)ₙ-Si(X₁)ₙ₋₄ formula (III)

In the formula, Rf represents a linear, branched or cyclic fluorine-containing alkyl group with 1 to 20 carbon atoms, or a fluorine-containing aromatic group with 6 to 14 carbon atoms. Rf is preferably a linear, branched or cyclic fluoroalkyl group with 3 to 10 carbon atoms, and more preferably a linear fluoroalkyl group with 4 to 8 carbon atoms. L₁ represents a divalent connecting group with 10 carbon atoms or less, preferably an alkyl group with 1 to 10 carbon atoms, and more preferably an alkylene group with 1 to 5 carbon atoms. The alkylene group is a linear or branched, substituted or non-substituted alkylene group that may internally have a connecting group (such as an ether group, an ester group or an amide group). The alkylene group may have a substituent, and, a preferred substituent in such case can be a halogen atom, a hydroxyl group, a mercapto group, a carboxyl group, an epoxy group, an alkyl group or an aryl group. X₁ has a same meaning as X in the formula (I), and is preferably a halogen, a hydroxyl group, or a non-substituted alkoxy group, more preferably a chlorine atom, a hydroxyl group or a non-substituted alkoxy group with 1 to 6 carbon atoms, further preferably a chlorine atom, a hydroxyl group or a non-substituted alkoxy group with 1 to 6 carbon atoms, further preferably a hydroxyl group, or an alkoxy group with 1 to 3 carbon atoms, and particularly preferably a methoxy group.

Among the fluorine-containing coupling agent represented by the formula (III), there is particularly preferred a fluorine-containing silane coupling agent represented by a following formula (IV):
CₙF₂ₙ₊₁—(CH₂)ₘ—Si(X₂)₃ formula (IV)

In the formula, n represents an integer of 1 to 10, and m represents an integer of 1 to 5. n is preferably 4 to 10, and m is preferably 1 to 3. X₂ represents a methoxy group, an ethoxy group or a chlorine atom.

The compounds represented by the formulas (I) to (IV) may be employed in a combination of two or more kinds. In the following, there are shown specific examples of the compounds represented by the formulas (I) to (IV), but the present invention is not limited to such examples.

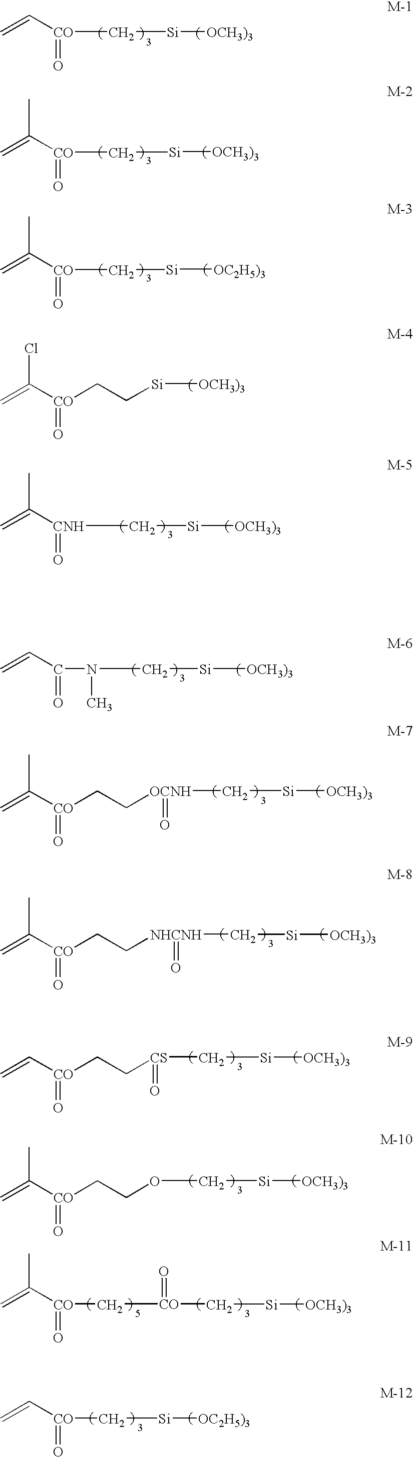

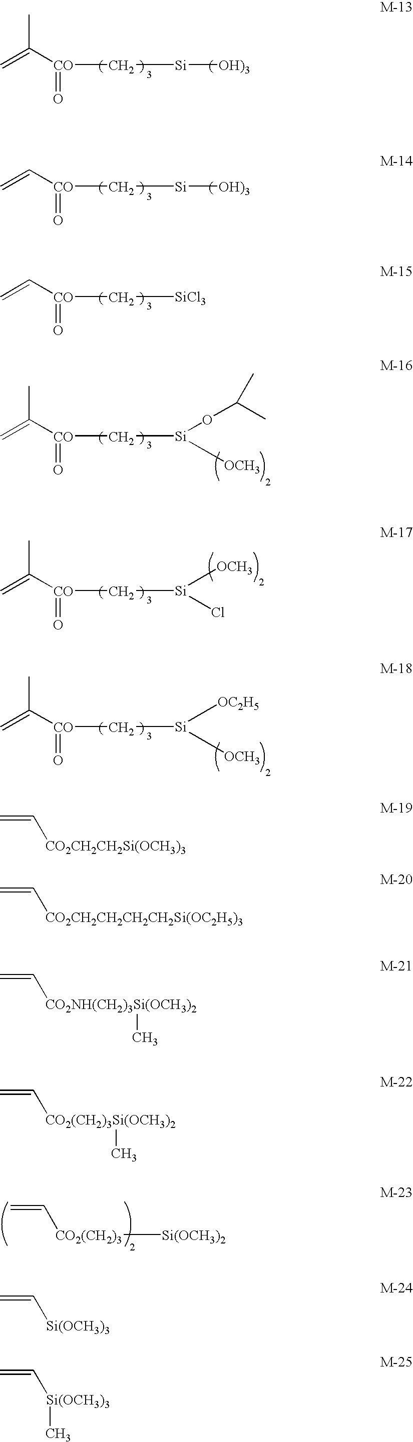

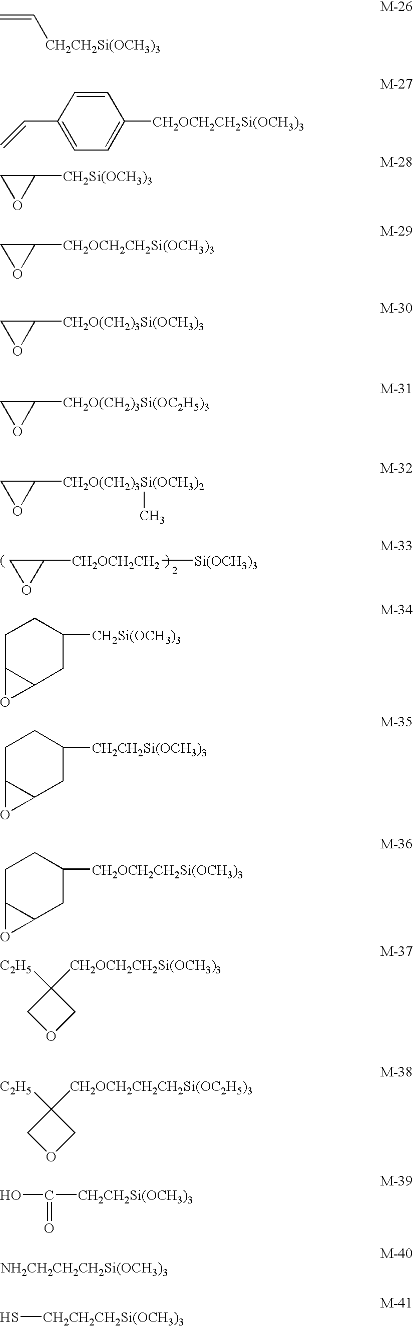

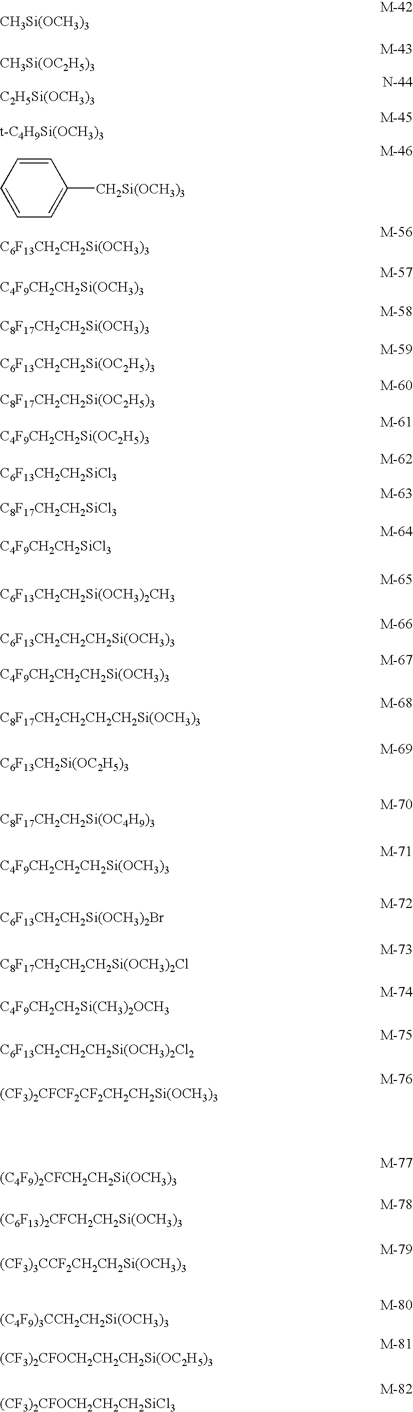

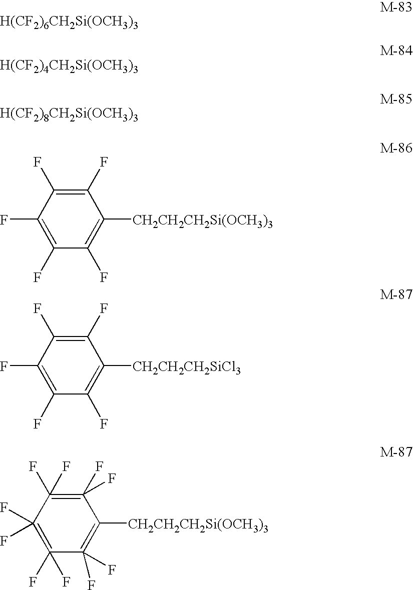

Among these specific examples, (M-1), (M-2), (M-30), (M-35), (M-49), (M-51), (M-56), and (M-57) are particularly preferred. Also compounds A, B and C described in a reference example of Japanese Patent No. 3474330 are preferable, showing an excellent dispersion stability.

In the present invention, it is also preferable to employ an organosilane compound represented by a following formula (V):

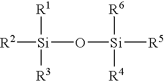

In the formula (V), R¹, R², R³, R⁴, R⁵ and R⁶ each independently represents a substituent selected from a group of an alkyl group with 1 to 20 carbon atoms, a phenyl group and a vinyl group, that may be arbitrarily substituted. The disiloxane compound can be hexamethylsiloxane, 1,3-dibutyltetramethyldisiloxane, 1,3-diphenyltetramethyldisiloxane, 1,3-divinyltetramethyldisiloxane, hexaethyldisiloxane, or 3-glycidoxypropylpentamethyldisiloxane, and hexamethyldisiloxane is particularly preferable.

In the present invention, the organosilane compound represented by the formulas (I) to (V) is not particularly restricted in an amount of use, but is preferably employed in an amount of 1 to 300 weight % with respect to the inorganic fine particles, more preferably 3 to 100 weight %, and most preferably 5 to 50 weight %. In a molar concentration based on hydroxyl groups on the surface of the inorganic oxide, there is preferred an amount of 1 to 300 mol. %, more preferably 5 to 300 mol. %, and most preferably 10 to 200 mol. %.

The organosilane compound employed in an amount within the aforementioned range provides a sufficient stabilizing effect for the dispersion liquid, and also improves a film strength at the film formation. It is also preferred to utilize plural organosilane compounds in combination, and such plural compounds may be added simultaneously or may be reacted by additions shifted in time. Also an addition of plural compounds by forming a partial condensate in advance facilitates a reaction control.

In the invention, a dispersibility of inorganic fine particles can be improved by reacting a hydrolysate of the organosilane and/or a partial condensate thereof.

A hydrolysis-condensation reaction is preferably conducted by adding water of 0.3 to 2.0 moles, preferably 0.5 to 1.0 mole, with respect to 1 mole of a hydrolysable group (X, X₁ or X₂) and executing an agitation at 15 to 100° C. in the presence of an acid catalyst or a metal chelate compound employed in the invention.

(Catalyst for Dispersibility Improving Treatment)

A dispersibility improving treatment by a hydrolysate and/or a condensate of the organosilane is preferably executed in the presence of a catalyst. The catalyst can be an inorganic acid such as hydrochloric acid, sulfuric acid or nitric acid; an organic acid such as oxalic acid, acetic acid, formic acid, methanesulfonic acid, or toluenesulfonic acid; an inorganic base such as sodium hydroxide, potassium hydroxide or ammonia; an organic base such as triethylamine or pyridine; or a metal alkoxide such as triisopropoxy aluminum or tetrabutoxy zirconium, but, in consideration of a manufacturing stability and a storage stability of the inorganic oxide fine particles, the present invention employs an acid catalyst (an inorganic acid or an organic acid) and/or a metal chelate compound. Among the inorganic acids, there is preferred hydrochloric acid or sulfuric acid, and, among the organic acids, an acid having an acid dissociation constant in water (pKa (25° C.)) of 4.5 or less is preferable. More preferable is hydrochloric acid, sulfuric acid or an organic acid having an acid dissociation constant in water of 3.0 or less, and further preferable is hydrochloric acid, sulfuric acid or an organic acid having an acid dissociation constant in water of 2.5 or less, further preferably an organic acid having an acid dissociation constant in water of 2.5 or less, further preferably methanesulfonic acid, oxalic acid, phthalic acid or malonic acid, and particularly preferably oxalic acid.

In case the hydrolysable group of organosiloxane is an alkoxy group and the acid catalyst is an organic acid, an amount of addition of water may be reduced as a carboxyl group or a sulfo group of the organic acid supplies a proton. An amount of addition of water is 0 to 2 moles with respect to 1 mole of the alkoxide group of the organosilane, preferably 0 to 1.5 moles, more preferably 0 to 1 mole, and particularly preferably 0 to 0.5 moles. Also in case of employing an alcohol as the solvent, there is also preferred a case of substantially not adding water.

In the invention, a metal chelate compound to be employed in the dispersibility improving treatment by a hydrolysate and/or a condensate of organosilane is preferably at least a metal chelate compound having at least a metal selected from Zr, Ti and Al as a central metal and having, as a ligand, an alcohol represented by a formula R³OH (R³ representing an alkyl group with 1 to 10 carbon atoms) and a compound represented by a formula R⁴COCH₂COR⁵ (R⁴ representing an alkyl group with 1 to 10 carbon atoms, and R⁵ representing an alkyl group with 1 to 10 carbon atoms or an alkoxy group with 1 to 10 carbon atoms).

The metal chelate compound can be advantageously without any particular restriction as long as it has a central metal selected from Zr, Ti and Al, and, within such range, two or more metal chelate compounds may be employed in combination. Preferred specific examples of the metal chelate compound to be employed in the invention include a zirconium chelate compound such as tri-n-butoxyethyl acetoacetate zirconium, di-n-butoxybis(ethyl acetoacetate) zirconium, n-butoxytris(ethyl acetoacetate) zirconium, tetrakis(n-propyl acetoacetate) zirconium, tetrakis(acetyl acetoacetate) zirconium, or tetrakis(ethyl acetoacetate) zirconium; a titanium chelate compound such as diisopropoxy-bis(ethyl acetoacetate) titanium, diisopropoxy-bis(acetyl acetoacetate) titanium, or diisopropoxy-bis(acetylacetone) titanium, and an aluminum chelate compound such as diisopropoxyethyl acetoacetate aluminum, diisopropoxyacetyl acetonate aluminum, isopropoxybis(ethyl acetoacetate) aluminum, isopropoxybis(acetyl acetonate) aluminum, tris(ethyl acetoacetate) aluminum, trio(acetyl acetonate) aluminum or monoacetyl acetonate-bis(ethyl acetoacetate) aluminum.

Among these metal chelate compounds, there is preferred tri-n-butoxyethyl acetoacetate zirconium, diisopropoxybis(acetyl acetonate) titanium, diisopropoxyethyl acetoacetate aluminum or tris(ethyl acetoacetate) aluminum. Such metal chelate compound may be employed singly or in a mixture of two or more kinds. Also a partial hydrolysate of such metal chelate compound may be employed.

Also in the invention, in order to disperse the inorganic fine particles from a powder state in a solvent, a dispersant may also be employed. In the invention, a dispersant having an anionic group is employed preferably.

An anionic group is effectively a group having an acidic proton such as a carboxyl group, a sulfonic acid (sulfo) group, a phosphoric acid (phosphono) group, or a sulfonamide group, or a salt thereof, preferably a carboxyl group, a sulfonic acid group, a phosphoric acid group or a salt thereof, and particularly preferably a carboxyl group or a phosphoric acid group. For further improving the dispersibility, the anionic group may be contained in plural units. It is preferably contained in 2 units or more in average, more preferably 5 units or more, and particularly preferably 10 units or more. Also the anionic group contained in the dispersant may be present in plural kinds within a molecule.

The dispersant may further include a crosslinking or polymerizing functional group. The crosslinking or polymerizing functional group can be an ethylenic unsaturated group capable of an addition polymerization reaction by radical species (such as a (meth)acryloyl group, an allyl group, a styryl group or a vinyloxy group), a cationic polymerizable group (such as an epoxy group, an oxatanyl group or a vinyloxy group), or a polycondensation reaction group (such as a hydrolysable silyl group or an N-methylol group), and preferably a functional group having an ethylenic unsaturated group.

(Material for Low Refractive Index Layer)

In the following, there will be explained a material preferably employed in the low refractive index layer of the invention. The low refractive index layer of the antireflection film of the invention is preferably formed by coating, crying and curing a curable composition, containing the aforementioned pore-containing fine particles.

In the invention, as components of the curable composition, there can be employed (I) a fluorine-containing polymer having a crosslinkable or polymerizable functional group, (II) a monomer having two or more ethylenic unsaturated groups, and (III) an organosilane compound.

((I) Fluorine-Containing Polymer)

In the invention, for the purpose of reducing the refractive index of the low refractive index layer and reducing the refractive index of the antireflection film, a polymer having a following fluorinated alkyl portion is preferably employed as a component of the curable composition, and is preferably crosslinkable.

The fluorine-containing monomer for introducing the fluorinated alkyl portion can be a fluoroolefin (such as fluoroethylene, vinylidene fluoride, tetrafluoroethylene, or hexafluoropropylene), a partially or completely fluorinated alkyl ester derivative of (meth)acrylic acid (such as Viscote 6FM (manufactured by Osaka Organic Chemical Industry Ltd.) or R-2020 (manufactured by Daikin Co.) or a completely or partially fluorinated vinyl ether, and preferably a perfluoroolefin, and, particularly preferably hexafluoropropylene in consideration of refractive index, solubility, transparency and availability. An increase in the composition ratio of such fluorine-containing vinyl monomer can lower the refractive index, but reduces the film strength. In the present invention, the fluorine-containing vinyl monomer is preferably introduced in such a manner that the copolymer has a fluorine content of 20 to 60 weight %, more preferably 25 to 55 weight %, and particularly preferably 30 to 50 weight %.

A constituent unit for providing a crosslinking reactivity can principally be (A), (B) or (C) shown in the following:

(A) a constituent unit obtained by a polymerization of a monomer having in advance a self-crosslinkable functional group within the molecule, such as glycidyl (meth)acrylate or glycidyl vinyl ether;

(B) a constituent unit obtained by a polymerization of a monomer having a carboxyl group, a hydroxyl group, an amino group or a sulfo group (such as (meth)acrylic acid, methylol (meth)acrylate, hydroxyalkyl (meth)acrylate, allyl acrylate, hydroxyethyl vinyl ether, hydroxybutyl vinyl ether, maleic acid or crotonic acid); or

(C) a constituent unit obtained by reacting a compound including a group reactive with the functional group of the aforementioned (A) or (B) and another crosslinkable functional group, with the aforementioned constituent unit (A) or (B) (such as a constituent unit that can be synthesized by reacting acrylic chloride with a hydroxyl group).

In the constituent unit (C), it is preferable, particularly in the invention, that the crosslinkable functional group is a photopolymerizable group. Such photopolymerizable group can be, for example, a (meth)acryloyl group, an alkenyl group, a cinnamoyl group, a cinnamylideneacetyl group, a benzalacetophenone group, a styrylpyridine group, an α-phenylmaleimide group, a phenylazide group, a sulfonylazide group, a carbonylazide group, a diazo group, an o-quinonediazide group, a furylacryloyl group, a coumarin group, a pyrone group, an anthracene group, a benzophenone group, a stilbene group, a dithiocarbamate group, a xanthate group, a 1,2,3-thiadiazole group, a cyclopropene group, or an azadioxabicyclo group, which may be employed singly or in a combination of two or more kinds. Among these, a (meth)acryloyl group or a cinnamoyl group is preferable, and a (meth)acryloyl group is particularly preferable.

For preparing a copolymer containing a photopolymerizable group there can be employed following methods, but the invention is not limited thereto:

(1) a method of reacting (meth)acryl chloride with a crosslinkable functional group-containing copolymer containing a hydroxyl group thereby forming an ester;

(2) a method of reacting a (meth)acrylate ester containing an isocyanate group with a crosslinkable functional group-containing copolymer containing a hydroxyl group thereby forming an urethane;

(3) a method of reacting (meth)acrylic acid with a crosslinkable functional group-containing copolymer containing an epoxy group thereby forming an ester; and

(4) a method of reacting a (meth)acrylate ester containing an epoxy group with a crosslinkable functional group-containing copolymer containing a carboxyl group thereby forming an ester.

An amount of introduction of the photopolymerizable group can be regulated arbitrarily, and it is also preferable to leave a certain amount of carboxyl group or hydroxyl group in view of improving a stability of the coated film state, reducing a surface failure in the presence of inorganic fine particles, and improving a film strength.

As a photopolymerizable group-containing polymer, the polymer having the fluorinated alkyl portion preferably has, in a side chain, a repeating unit having a (meth)acryloyl group as an essential constituent component. An increase of such (meth)acryloyl group-containing repeating unit in the composition ratio improves the film strength but also elevates the refractive index. Though dependent also in the type of the repeating unit derived from the fluorine-containing vinyl monomer, the (meth)acryloyl group-containing repeating unit is generally represent preferably a proportion of 5 to 90 weight %, more preferably 30 to 70 weight %, and particularly preferably 40 to 60 weight %.

In the polymer having the fluorinate alkyl portion, in addition to the repeating unit derived from the aforementioned fluorine-containing vinyl monomer and the repeating unit having a (meth)acryloyl group in the side chain, another vinyl monomer may be suitably copolymerized in consideration of various points such as an adhesion to a base material, a Tg of polymer (contributing to the film hardness), a solubility in solvent, a transparency, a lubricating property, and dust and smear preventing properties. Such vinyl monomer may be employed in a combination of plural kinds according to the purpose, and is preferably introduced within a range of 0 to 65 mol. % in total within the copolymer, more preferably within a range of 0 to 40 mol. % and particularly preferably within a range of 0 to 30 mol. %.

A monomer usable in combination is not particularly restricted and can be, for example, an olefin (such as ethylene, propylene, isoprene, vinyl chloride or vinylidene chloride), an acrylate ester (such as methyl acrylate, ethyl acrylate, 2-ethylhexyl acrylate or 2-hydroxyethyl acrylate), a methacrylate ester (such as methyl methacrylate, ethyl methacrylate, butyl methacrylate or 2-hydroxyethyl methacrylate), a styrene derivative (such as styrene, p-hydroxymethylstyrene or p-methoxystyrene), a vinyl ether (such as methyl vinyl ether, ethyl vinyl ether, cyclohexyl vinyl ether, hydroxyethyl vinyl ether, or hydroxybutyl vinyl ether), a vinyl ester (such as vinyl acetate, vinyl propionate, or vinyl cinnamate), an unsaturated carboxylic acid (such as acrylic acid, methacrylic acid, crotonic acid, maleic acid or itacolic acid), an acrylamide (such as N,N-dimethyl acrylamide, N-tert-butyl acrylamide or N-cyclohexyl acrylamide), a methacrylamide (such as N,N-dimethylmeth acrylamide) or acrylonitrile.

For the purpose of reducing the refractive index of the low refractive index layer and providing an excellent scratch resistance, the fluorine-containing polymer particularly useful in the invention is a random copolymer of a perfluoroolefin and a vinyl ether or a vinyl ester. In particular, it preferably contains a group singly capable of a crosslinking reaction (for example a radical reactive group such as a (meth)acryloyl group, or a ring-opening polymerizable group such as an epoxy group or an oxetanyl group). Such crosslinking reactive group-containing polymerization unit preferably represents 5 to 70 mol. % of all the polymerization units of the polymer, particularly preferably 30 to 60 mol. %. Preferred polymers include those described for example in JP-A Nos. 2002-243907, 3003-372601, 2003-26732, 2003-222702, 2003-294911, 2003-329804, 2004-4444 and 2004-45462. Among these, a polymer represented by formulas I and 2 in JP-A No. 2004-45462 is preferred, specific examples and a synthesizing method thereof are described in paragraphs (0043) to (0053) and (0079) to (0082) therein.

Also in the fluorine-containing polymer of the invention, a polysiloxane structure is preferably introduced in order to provide an antistain property. A method of introducing the polysiloxane structure is not particularly restricted, but there is preferred a method, as described in JP-A Nos. 6-9311, 11-189621, 11-228631 and 2000-313709, of introducing a polysiloxane block copolymerizing component utilizing a silicone macroazo initiator, or a method, as described in JP-A No. 2-251555 and 2-308806, of introducing a polysiloxane copolymerizing component utilizing a silicone macromer. A particularly preferred compound can be a polymer described in JP-A No. 11-189621, Examples 1, 2 and 3, or a copolymer A-2 or A-3 described in JP-A No. 2-251555. Such polysiloxane component preferably constitutes 0.5 to 10 weight % of the polymer, particularly preferably 1 to 5 weight %.

The polymer preferably employable in the invention has a weight-averaged molecular weight of 5,000 or higher, preferably 10,000 to 500,000 and most preferably 15,000 to 200,000. It is also possible to improve a coated film state or a scratch resistance by utilizing polymers of different average molecular weights in combination.

The aforementioned polymer may be employed in combination with a curing agent having a suitable polymerizable unsaturated group, as described in JP-A Nos. 10-25388, and 2000-17028. Also there is preferred a combination with a compound having a fluorine-containing polyfunctional polymerizable unsaturated group, as described in JP-A No. 2002-145952. The compound having a polyfunctional polymerizable unsaturated group can be (II) a monomer having two or more ethylenic saturated groups to be explained later. Such compound has a large effect of improving the scratch resistance, particularly in case of a combination with a compound having a polymerizable unsaturated group in the main polymer.

In case the polymer itself does not have a sufficient curing property, a necessary curing property can be provided by blending a crosslinkable compound. For example, in case the main polymer has a hydroxyl group, various amino compounds are preferably employed as a curing agent. The amino compound employed as the crosslinkable compound is for example a compound having a hydroxyalkylamino group and/or an alkoxyalkylamino group by two or more units in total, and more specifically can be a melamine compound, a urea compound, a benzoguanamine compound, or a glycoluryl compound.

A melamine compound is generally known to have a skeleton of a triazine ring to which a nitrogen atom is bonded, such as melamine, an alkylated melamine, methylolmelamine or an alkoxylated methylmelamine, but preferably contains a methylol group and/or an alkoxylated methyl group by two or more units in total within a molecule. More specifically there is preferred a methylolated melamine obtained by reacting melamine and formaldehyde under a basic condition, an alkoxylated melamine or a derivative thereof, and an alkoxylated melamine is particularly preferable in obtaining a satisfactory storability and a satisfactory reactivity in a curable resin composition. The methylolated melamine or alkoxylated methylmelamine to be employed as the crosslinkable compound is not particularly restricted, and there can also be utilized various resinous substances obtainable by a method described for example in Plastic Zairyo Koza, [8] urea and melamine resins (published by Nik an Kogyo Shimbun).

Also a urea compound can be, in addition to urea, a polymethylolated urea, an alkoxylated methylurea as a derivative thereof, a methylolated urea having a urone ring or alkoxylated methylurone. Also in the urea derivatives, various resinous substances described in the aforementioned literature can be employed.

((II) Monomer Containing Two or More Ethylenic Unsaturated Groups)

As the material for constituting the low refractive index layer, there is also preferred a curable composition containing the pore-containing fine particles of the invention and a film-forming binder to be explained later (for example a monomer having two or more ethylenic unsaturated groups).

Examples of a monomer having two or more ethylenic unsaturated groups include an ester of a polyhydric alcohol and (meth)acrylic acid (such as ethylene glycol di(meth)acrylate, butanediol di(meth)acrylate, hexanediol di(meth)acrylate, 1,4-cyclohexanediol diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate or polyester polyacrylate), an ethylene oxide denatured substance of the aforementioned ester, vinylbenzene and derivatives thereof (such as 1,4-divinylbenzene, 2-acryloylethyl 4-vinylbenzoate, or 1,4-divinylcyclohexanone), a vinylsulfone (such as divinylsulfone), an acrylamide (such as methylenebisacrylamide), and methacrylamide. Such monomer may be employed in a combination of two or more kinds. Such monomer can increase the density the crosslinking groups in the binder, and can formed a cured film of a high hardness, but has a refractive index not lower than that of the fluorine-containing polymer. However, a combination with inorganic fine particles of a hollow structure having a low refractive index allows to obtain a refractive index sufficiently usable as the low refractive index layer of the invention.

Instead of or in addition to the polymer having the fluorinated alkyl portion and a monomer having two or more ethylenic unsaturated groups as a film forming binder, a monomer having a crosslinking functional group may be employed to introduce a crosslinking functional group into the polymer, thereby introducing a crosslinked structure into the binder polymer.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Also vinylsulfonic acid, an acid anhydride, a cyanoacrylate derivative, melamine, etherified methylol, an ester, an urethane or a metal alkoxide such as tetramethoxysilane can be utilized as a monomer for introducing a crosslinked structure. There can also be employed a functional group capable of showing a crosslinking property as a result of a decomposition reaction, such as block isocyanate group. Thus, in the invention, the crosslinking functional group need not necessarily be a group immediately capable of a reaction but showing a reactivity after a decomposition reaction.

The binder polymer having such crosslinking functional group can form a crosslinked structure by heating after coating.

The binder polymer having such crosslinking functional group may form a crosslinking polymer by a reaction with the polymer prior to the coating of the antireflection film, but may also form a matrix by a crosslinking with the main polymer only after the coating.

((III) Organosilane Compound)

In the invention, a hydrolysate of organosilane and/or a partial condensate thereof is preferably added as it can improve the film strength by a combined use with the aforementioned binder curable with an ionizing radiation or heat. For synthesizing a partial condensate (hereinafter abbreviated as sol) of the organosilane compound, there can be employed an organosilane compound employed in the dispersibility improving treatment of the inorganic oxide fine particles of the invention, and an acid and/or a metal chelate compound as a catalyst.

In the invention, a binder that can be advantageously employed other than the aforementioned photo- or heat-curable binder can be a hydrolysate of an organosilane compound represented by the aforementioned formulas (I)-(IV) and/or a partial condensate itself A fluorinated alkyl portion present in the organosilane compound is preferable in reducing the refractive index. Examples of the preferred binder are described for example in JP-A Nos. 2002-202406, 2002-265866 and 2002-317152.

In the low refractive index layer, an amount of the organosilane sol to the polymer having the fluorinated alkyl portion is preferably 5 to 100 weight %, in consideration of an effect of the use of the sol, a refractive index of the layer, and a shape and a surface property of the layer to be formed, more preferably 5 to 40 weight %, further preferably 8 to 35 weight % and particularly preferably 10 to 30 weight %.

In the invention, a β-diketone compound and/or a β-ketoester compound is preferably added further to the curable composition for forming the low refractive index layer. Specific examples of the β-diketone compound and/or the β-ketoester compound include acetylacetone, methyl acetoacetate, ethyl acetoacetate, n-propyl acetoacetate, i-propyl acetoacetate, n-butyl acetoacetate, sec-butyl acetoacetate; t-butyl acetoacetate, hexane-2,4-dione, heptane-2,4-dione, heptane-3,5-dione, octane-2,4-dione, nonane-2,4-dione, and 5-methyl-hexane-dione, among which ethyl acetoacetate and acetylacetone are preferred and acetylacetone is particularly preferred. Such β-diketone compound and/or β-ketoester compound may be employed singly or in a mixture of two or more kinds. In the invention, the β-diketone compound and/or the β-ketoester compound is preferably employed in an amount of 2 moles or more with respect to 1 mole of the metal chelate compound, more preferably 3 to 20 moles. An amount less than 2 moles may results in an insufficient storage stability of the obtained composition.

In the low refractive index layer of the invention, there can be employed a compound capable of generating a radical or an acid by an irradiation of an ionizing radiation or heat.

(Photoradical Initiator)

The photoradical polymerization initiator can be, for example, an acetophenone, a benzoin, a benzophenone, a phosphine oxide, a chetal, an anthraquinone, a thioxanthone, an azo compound a peroxide, a 2,3-dialkyldione compound, a disulfide compound, a fluoroamine compound, an aromatic sulfonium, a lophine dimer, an onium salt, a borate salt, an active ester, an active halogen, an inorganic complex or a coumarin.

Examples of the acetophenone include 2,2-dimethoxyacetophenone, 2,2-diethoxyacetophenone, p-dimethylacetophenone, 1-hydroxy-dimethyl phenyl ketone, 1-hydroxydimethyl p-isopropylphenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, 4-phenoxydichloroacetophenone and 4-t-butyl-dichloroacetophenone.

Examples of the benzoin include benzoin, benzoin methyl ether, benzoin ethyl ether, benzoin isopropyl ether, benzyldimethyl chetal, benzoin benzenesulfonate ester, benzoin toluenesulfonate ester, benzoin methyl ether, benzoin ethyl ether and benzoin isopropyl ether.

Examples of the benzophenone include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone Michler's ketone, and 3,3′4,4′-tetra(t-butylperoxycarbonyl)benzophenone.

Examples of the active ester include 1,2-octanedione, 1-(4-(phenylthio)-2-(o-benzoyloxime)), a sulfonate ester and a cyclic active ester compound.

More specifically there are preferred compounds 1 to 21 described in examples of JP-A No. 2000-80068.

Examples of the onium salt include an aromatic diazonium salt, an aromatic iodonium salt and an aromatic sulfonium salt.

Examples of the borate salt include an ion complex with a cationic dye.

Examples of the active halogen include s-triazine and an oxathiazole compound, such as 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethylacetate)amino)phenyl)-4,6-bis(trichloromethyl)-s-triazine, and 2-trihalomethyl-5-(p-methoxyphenyl)-1,3,4-oxadiazole. More specifically there are preferred compounds described in JP-A No. 58-15503, p. 14-30; JP-A No. 55-77742, p. 6 to 10; compounds Nos. 1 to 8 in JP-B No. 60-27673, p. 287; compounds Nos. 1 to 17 in JP-A No. 60-239736, p. 443 to 444; and compounds Nos. 1 to 19 in U.S. Pat. No. 4,701,399.

Examples of the inorganic complex include bis(η⁵-2,4-cyclopentadien-1-yl)bis(2.6-difluoro-3-(1H-pyrrol-1-yl)phenyl)titanium.

Examples of the coumarin include 3-chetocoumarin.

Such initiator may be employed singly or in a mixture.

Various examples useful for the invention are also described in “Latest UV curing technology” (Gijutsu Joho Kyokai, p. 159, 1991). “Ultraviolet curing system”, Kiyoshi Katoh, 1989, Sogo Gijutsu Center, p. 65 to 148.

Preferred examples of the commercially available photoradical polymerization initiator of photocleavable type include Irgacure manufactured by Ciba Specialty Chemicals Inc. (651, 184, 819, 907, 369, 1870 (mixture of CGI-403/Irg-187=7/3), 500, 369, 1173, 2959, 4265, 4263, OXE01 etc.), Kayacure manufactured by Nippon Kayaku Co. (DETX-S, BP-100, BDMK, CTX, BMS, 2-EAQ, ABQ, CPTX, EPD, ITX, QTX, BTC, MCA etc.), and Esacure manufactured by Sartomer Co. (KIP100F, KB1, EB3, BP, X33, KT046, KT37, KIP150, TZT etc.) and combinations thereof.

The photopolymerization initiator is preferably employed within a range of 0.1 to 15 parts by weight with respect to 100 parts by weight of the binder, more preferably 1 to 10 parts by weight. Also in order to prevent an evaporation from a coated film in a drying step after the coating, the polymerization initiator preferably has a molecular weight of 250 to 1,000 and more preferably 300 to 1,000.

A photosensitizer may be employed in addition to the photopolymerization initiator. Examples of the photosensitizer include n-butylamine, triethylamine, tri-n-butylphosphine, Michler's ketone and thioxanthone.

Also an auxiliary agent such as an azide compound, a thiourea compound or a mercapto compound may be used in combination, by one or more kinds.

Examples of the commercially available photosensitizer include Kayacure manufactured by Nippon Kayaku Co. (DMBI, or EPA).

(Thermal Radical Initiator)

The thermal radical initiator can be an organic or inorganic peroxide, an organic azo or diazo compound.

More specifically, an organic peroxide can be benzoyl peroxide, halogenated benzoyl peroxide, lauroyl peroxide, acetyl peroxide, dibutyl peroxide, cumene hydroperoxide, or butyl hydroperoxide; an inorganic peroxide can be hydrogen peroxide, ammonium persulfate, or potassium persulfate; an azo compound can be 2,2′-azobis(isobutyronitrile), 2,2′-azobis(isopropionitrile), or 1,1′-azobis(cyclohexanecarbonitrile); and a diazo compound can be diazoaminobenzene or p-nitrobenzene diazonium.

(Thermal Acid Generator)

Specific examples of the thermal acid generator include an aliphatic sulfonic acid and a salt thereof, an aliphatic carboxylic acid such as citric acid, acetic acid, or maleic acid and a salt thereof, an aromatic carboxylic acid such as benzoic acid, or phthalic acid and a salt thereof, an alkylbenzenesulfonic acid and an ammonium salt thereof, an amine salt, a metal salt, phosphoric acid and a phosphate ester of an organic acid.

Examples of commercially available material include Catalyst 4040, Catalyst 4050, Catalyst 600, Catalyst 602, Catalyst 500 and Catalyst 296-9 (foregoing manufactured by Nippon Cytec Industries Co.), Nacure series 155, 1051, 5076, 4054J and block type Nacure series 2500, 5225, X49-110, 3525 and 4167 (foregoing manufactured by King Ltd.).

Such thermal acid generator is preferably employed in an amount of 0.01 to 10 parts by weight with respect to 100 parts by weight of the curable resin composition, and more preferably 0.1 to 5 parts by weight. An amount within such range provides a satisfactory storage stability of the curable resin composition and a satisfactory scratch resistance in the coated film.

(Photoacid Generator)

The photoacid generator can be, for example, (1) an onium salt such as an iodonium salt, a sulfonium salt, a phosphonium salt, a diazonium salt, an ammonium salt or a pyridinium salt; (2) a sulfone compound such as a β-ketoester, a β-sulfonylsulfone or an α-diazo compound thereof; (3) a sulfonate ester such as an alkylsulfonate ester, a haloalkylsulfonate ester, an arylsulfonate ester or an imisulfonate; (4) a sulfonimide compound; or (5) a diazomethane compound. Such photoacid generator is preferably employed in 0.01 to 10 parts by weight with respect to 100 parts by weight of the curable resin composition, more preferably 0.1 to 5 parts by weight.

(Addition of Component Reducing Surface Free Energy)

In the invention, it is preferable to reduce a free energy of the surface of the antireflection film in order to improve the antismear property. More specifically, it is preferable to employ a fluorine-containing compound or a compound having a dialkylsiloxane portion in the low refractive index layer. As an additive having a dialkylsiloxane portion, there can be advantageously employed a reactive group-containing polysiloxane (such as X-22-174DX, X-22-2426, X-22-164B, X-22-164C, X-22-170DX, X-22-176D, or X-22-1821 (trade names, manufactured by Shin-etsu Chemical Co.), FM-0725, FM-7725, FM-4421, FM-5521, FM-6621, or FM-1121 (trade names, manufactured by Chisso Ltd.), DMS-U22, RMS-033, RMS-083, UMS-182, DMS-H21, DMS-H31, HMS-301, FMS121, FMS123, FMS131, FMS141 or FMS221 (trade names, manufactured by Gelest Inc.). Also silicone compounds described in JP-A No. 2003-112383, Tables 2 and 3 may be advantageously employed. Such polysiloxane is preferably added within a range of 0.1 to 10 weight % of the total solids of the low refractive index layer, particularly preferably 1 to 5 weight %.

It is also preferable to provide an antismear layer of a silane coupling agent containing a perfluoro ether group, as described in JP-A No. 2002-277604.

(Physical Properties of Low Refractive Index Layer)

The low refractive index layer preferably has a refractive index of 1.20 to 1.46, more preferably 1.25 to 1.40 and particularly preferably 1.25 to 1.38.

The low refractive index layer preferably has a thickness of 50 to 200 nm, and further preferably 70 to 120 nm. The low refractive index layer preferably has a haze of 3% or less, more preferably 2% or less, and most preferably 1% or less.

The low refractive index layer preferably has a strength of H or higher in a pencil hardness test under a load of 500 g, more preferably 2H or higher and most preferably 3H or higher.

Also in order to improve the antismear property of the optical film, the surface preferably has a contact angle to water of 90° or higher, more preferably 95° or higher and particularly preferably 100° or higher.

(Layer Structure of Antireflection Film)

The antireflection film of the invention is formed, on a transparent base material, by providing a hard coat layer to be explained later if necessary, and laminating thereon layers thereon in consideration of a refractive index, a film thickness, a number of layers, an order of layers and the like so as to reduce the reflectance by an optical interference. In a simplest configuration, the antireflection film is formed by coating only a low refractive index layer on the base material. For further reducing the reflectance, it is preferable to combine a high refractive index layer having a refractive index higher than that of the base material and a low refractive index layer having a refractive index lower than that of the base material. Examples of structure include a two-layered structure of high refractive index layer/low refractive index layer from the side of the base material and a three-layered structure in which three layers of different refractive indexes are laminated in an order of medium refractive index layer (having a refractive index higher than that of the base material or the hard coat layer but lower than that of the high refractive index layer)/high refractive index layer/low refractive index layer, and laminated structures with a larger number of layers are also proposed. Among these, in consideration of a durability, optical characteristics, a cost and a productivity, it is preferred to coat in an order of medium refractive index layer/high refractive index layer/low refractive index layer on a base material having a hard coat layer.

In the following examples of a preferred layer configuration of the antireflection film of the invention will be shown. In the following configurations, the base film functions as a substrate:
base film/low refractive index layer
base film/antistatic layer/low refractive index layer
base film/antiglare layer/low refractive index layer
base film/antiglare layer/antistatic layer/low refractive index layer
base film/hard coat layer/antiglare layer/low refractive index layer
base film/hard coat layer/antiglare layer/antistatic layer/low refractive index layer
base film/hard coat layer/antistatic layer/antiglare layer/low refractive index layer
base film/hard coat layer/high refractive index layer/low refractive index layer
base film/hard coat layer/antistatic layer/high refractive index layer/low refractive index layer
base film/hard coat layer/medium refractive index layer/high refractive index layer/low refractive index layer
base film/antiglare layer/high refractive index layer/low refractive index layer
base film/antiglare layer/medium refractive index layer/high refractive index layer/low refractive index layer
base film/antistatic layer/hard coat layer/medium refractive index layer/high refractive index layer/low refractive index layer
antistatic layer/base film/hard coat layer/medium refractive index layer/high refractive index layer/low refractive index layer
base film/antistatic layer/antiglare layer/medium refractive index layer/high refractive index layer/low refractive index layer
antistatic layer/base film/antiglare layer/medium refractive index layer/high refractive index layer/low refractive index layer
antistatic layer/base film/antiglare layer/high refractive index layer/low refractive index layer/high refractive index layer/low refractive index layer

The layered structure is not limited to such examples as long as the reflectance can be reduced by an optical interference. The high refractive index layer may be a light diffusing layer without an antiglare property.

Also the antistatic layer is preferably a layer containing conductive polymer particles or metal oxide fine particles (such as ATO or ITO), and can be provided by a coating or an atmospheric pressure plasma process.

(Film Forming Binder)

In the invention, as a principal film forming binder component of a film forming composition for forming a hard coat layer or a high (medium) refractive index layer, there is preferably a compound having an ethylenic unsaturated group, in consideration of a film strength, a stability of the coating liquid and a productivity of the coated film. The principal film forming binder means a component representing 10 weight % or more in the film forming components other than the inorganic fine particles, preferably representing 20 to 100 weight % and further preferably 30 to 95 weight %.

It is preferably a polymer having a saturated hydrocarbon chain or a polyether chain as a main chain, and more preferably a polymer having a saturated hydrocarbon chain as a main chain. As the binder polymer having a saturated hydrocarbon chain as a main chain, there is preferred a polymer of an ethylenic unsaturated monomer. Also as the binder polymer having a saturated hydrocarbon chain as a main chain and having a crosslinked structure, there is preferred a (co)polymer of a monomer having two or more ethylenic unsaturated groups.

For obtaining a high refractive index, there is preferably selected a monomer structure containing an aromatic ring or at least an atom selected from a non-fluorine halogen atom, a sulfur atom, a phosphor atom and a nitrogen atom.

Examples of a monomer having two or more ethylenic unsaturated groups include an ester of a polyhydric alcohol and (meth)acrylic acid (such as ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, or polyester polyacrylate), vinylbenzene and a derivative thereof (such as 1,4-divinylbenzene, 4-vinylbenzoic acid 2-acryloylethyl ester, or 1,4-divinylcyclohexanone), a vinylsulfone (such as divinylsulfone), an acrylamide (such as methylenebisacrylamide) and a methacrylamide. Such monomer may be employed in a combination of two or more kinds. In the present specification, an expressure “(meth)acrylate” means “acrylate or methacrylate”.

Specific examples of the high refractive index monomer include bis(4-methacryloylthiophenyl) sulfide, vinylnaphthalene, vinylphenyl sulfide and 4-methacryloxyphenyl-4′-methoxyphenyl thioether. Such monomer can also be employed in a combination of two or more kinds.

Polymerization of such monomer having ethylenic unsaturated groups can be executed by an irradiation with an ionizing radiation or by heating, in the presence of a photoradical initiator or a thermal radical initiator.

In the invention, a polymer having a polyether as a main chain may also be employed.

It is preferably a ring-opening polymer of a polyfunctional epoxy compound. A ring-opening polymerization of the polyfunctional epoxy compound can be executed by an irradiation with an ionizing radiation or by heating, in the presence of a photoacid generating agent or a thermal acid generating agent.

It is also possible to employ a monomer having a crosslinking functional group, instead of or in addition to a monomer having two or more ethylenic unsaturated groups, thereby introducing a crosslinkable functional group in the polymer, and, utilizing a function of such crosslinkable functional group, to introduce a crosslinked structure into the binder polymer.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Also vinylsulfonic acid, an acid anhydride, a cyanoacrylate derivative, melamine, etherified methylol, an ester, an urethane or a metal alkoxide such as tetramethoxysilane can be utilized as a monomer for introducing a crosslinked structure. There can also be employed a functional group capable of showing a crosslinking property as a result of a decomposition reaction, such as block isocyanate group. Thus, in the invention, the crosslinking functional group need not necessarily be a group immediately capable of a reaction but showing a reactivity after a decomposition reaction.

The binder polymer having such crosslinking functional group can form a crosslinked structure by heating after coating.

In the invention, a high refractive index layer is preferably provided. The high refractive index layer can be formed from the aforementioned film forming binder, matting particles for providing an antiglare property or an internal scattering property, and an inorganic filter for attaining a high refractive index, a prevention of a shrinkage by crosslinking and a high strength.

The high refractive index layer may include, for the purpose of providing an antiglare property, matting particles larger than the filler particles and having an average particle size of 0.1 to 5.0 μm, preferably 1.5 to 3.5 μm, such as particles of all inorganic compound or resin particles. A difference between the refractive indexes of the matting particles and the binder is preferably 0.02 to 0.20, and particularly preferably 0.04 to 0.10, since an excessively large difference results in a turbidity in the film while an excessively small difference cannot provide a sufficient light diffusing effect. Also an amount of addition of the matting particles to the binder is preferably 3 to 30 weight % and particularly preferably 5 to 20 weight %, since, like the refractive index, an excessively large amount results in a turbidity in the film while an excessively small amount cannot provide a sufficient light diffusing effect.

Specific examples of the matting particles preferably include particles of an inorganic compound such as silica particles, or TiO₂ particles; and resin particles such as acryl particles, crosslinked acryl particles, polystyrene particles, crosslinked styrene particles, melamine resin particles, or benzoguanamine resin particles. Among these crosslinked styrene particles, crosslinked acryl particles, or silica particles are preferred.

The matting particles may have a spherical or amorphous shape.

Also there may be employed matting particles of two or more kinds of different particle sizes. In case of employing the matting particles of two or more kinds, a difference in the refractive index is preferably 0.02 to 0.10, and particularly preferably 0.03 to 0.07, in order to effectively attain a control of the refractive index by the mixing. It is also possible to provide an antiglare property with the matting particles of a larger particle size and to provide another optical property with the matting particles of a smaller particle size. In case of applying an optical film on a high-definition display of 133 ppi or higher, an absence of a defect in optical performance, called glittering, is required. Such glittering is caused by a fact that pixels are enlarged or contracted by irregularities (contributing to the antiglare property) present on the film surface, whereby the luminance loses uniformity, but such phenomenon can be significantly alleviated by employing matting particles, smaller than the matting particles providing the antiglare property and having a refractive index different from that of the binder.

A particle size distribution of the matting particles is most preferably a single dispersion, and the particles preferably have as mutually close as possible in size. By defining a particle having a size larger by 20% or more than an average particle size as a coarse particle, a proportion of such coarse particles is preferably 1% or less of a number of all the particles, more preferably 0.1% or less and further preferably 0.01% or less. Matting particles having such particle size distribution can be obtained by executing a classification after an ordinary synthesizing reaction, and matting particles of a more preferable distribution can be obtained for example by increasing the number of classifications or by increasing a level thereof.

Such matting particles are contained in the hard coat layer in such a manner that an amount of the matting particles therein is preferably 10 to 1000 mg/m², more preferably 100 to 700 mg/m².

A particle size distribution of the matting particles is measured by a Coulter counter and is converted into a number distribution of the particles.

In the high refractive index layer, in order to increase the refractive index of the layer and to reduce a shrinkage at curing, there is preferably contained an inorganic filler constituted of at least an oxide of a metal selected from titanium, zirconium, aluminum, indium, zinc, tin and antimony and having an average particle size of 0.2 μm or less, preferably 0.1 μm or less and further preferably 0.06 μm or less.

Also in order to maintain a large difference in the refractive index from the matting particles, and, in a high refractive index layer utilizing high refractive index matting particles, in order to maintain the layer at a low refractive index, it is preferable to employ a silicon oxide as the filler. A preferred particle size is same as that of the inorganic filler. For this purpose, the pore-containing organic fine particles of the invention may also be employed.

Specific examples of the inorganic filler to be employed in the high refractive index layer include TiO₂, ZrO₂, Al₂O₃, In₂O₃, ZnO, SnO₂, Sb₂O₃, ITO and SiO₂. TiO₂ and ZrO₂ are particularly preferable in obtaining a high refractive index. The inorganic filler may also be preferably subjected, on the surface thereof, to a silane coupling treatment or a titanium coupling treatment, and a surface treating agent having a functional group capable of reacting with the binder is preferably employed on the filler surface.

An amount of such inorganic filler is preferably 10 to 90% of the entire weight of the high refractive index layer, more preferably 20 to 80% and particularly preferably 30 to 70%.

Such filler does not cause a light scattering as its particle size is sufficiently smaller than a wavelength of the light, and a dispersion substance formed by dispersing such filler in the binder polymer behaves as an optically uniform medium. A bulk refractive index of the mixture of the binder and the inorganic filler of the high refractive index layer is preferably 1.48 to 2.00, more preferably 1.50 to 1.80. A refractive index within such range can be realized by suitably selecting types and proportions of the binder and the inorganic filler. Such selection can be easily made by executing an experiment in advance.

In the antireflection film of the invention, it is also preferable to provide a medium refractive index layer having a refractive index lower than that of the high refractive index layer and higher than that of the substrate, and such medium refractive index layer can be formed in a similar manner as the high refractive index layer, by regulating amounts of the high refractive index filler and the high refractive index monomer employed in the high refractive index layer.

The optical film of the invention has a haze within a range of 3 to 70%, preferably 4 to 60%, and an average reflectance within 450 to 650 nm of 3.0% or less, preferably 2.5% or less.

The optical film of the invention, having a haze and an average reflectance within the aforementioned ranges, can achieve an antiglare property, an internal scattering property and an antireflection property of a satisfactory level, without a deterioration in a transmitted light.

As a transparent substrate for the optical film of the invention, a plastic film is preferably employed. A polymer constituting the plastic film can be a cellulose ester (for example triacetyl cellulose or diacetyl cellulose, representatively TAC-TD80U or TD30UF manufactured by Fuji Photo Film Co.), polyamide, polycarbonate, polyester (such as polyethylene phthalate or polyethylene naphthalate), polystyrene, polyolefin, a norbornene resin (such as Arton (trade name) manufactured by JSR Corp.), or amorphous polyolefin (such as Zeonex (trade name) manufactured by Nippon Zeon Corp.). Among these, triacetyl cellulose, polyethylene terephthalate or polyethylene naphthalate is preferable, and triacetyl cellulose is particularly preferable. Also a cellulose acylate film substantially free from a halogenated hydrocarbon such as dichloromethane and a producing method thereof are described in detail in the Japan Institute of Invention and Innovation, Laid-open Technical Report (2001-1745, issued Mar. 15, 2001, JIII) (hereinafter abbreviated as Laid-open Technical Report 2001-1745), and cellulose acylates described herein can be advantageously utilized also in the present invention.

(Saponification Process)

The optical film of the invention, in case applied to a liquid crystal display apparatus, is provided on an outermost surface of the display for example by forming an adhesive layer on a side. In case the transparent substrate is formed by triacetyl cellulose, since triacetyl cellulose is employed as a protective film for a polarizing layer of a polarizing plate, it is advantageous in cost to employ the optical film of the invention as the protective film.

The optical film of the invention, in case provided on the outermost surface of a display for example by forming an adhesive layer on a side, or in case employed as a protective film of the polarizing plate, is preferably subjected to a saponification process for achieving a sufficient adhesion, after an outermost layer principally constituted of a fluorine-containing polymer is formed on the transparent substrate. The saponification process is executed by a known method, such as an immersion of the film in an alkali solution for a suitable time. After the immersion in the alkali solution, the film is preferably washed sufficiently with water or immersed in a dilute acid to neutralize the alkali component in order that the alkali component does not remain in the film.

The saponification process renders a surface of the transparent substrate, opposite to a side having the outermost layer, hydrophilic.

The hydrophilic surface is particularly effective for improving an adhesive property to a polarizing film principally constituted of polyvinyl alcohol. Also the hydrophilic surface, retarding deposition of dusts in the air, hinders entry of dusts between the polarizing film and the optical film at the adhesion to the polarizing film and is thus effective for preventing a point-shaped defect caused by dusts.

The saponification process is preferably executed in such a manner that a surface of the transparent substrate, opposite to the side having the outermost layer, has a contact angle to water of 400 or less, more preferably 30° or less and particularly preferably 20° or less.

A specific method of the saponification process can be selected from following methods (1) and (2). The method (1) is superior in that the process can be executed in the same manner as in the ordinary triacetyl cellulose film, but saponifies also the surface of the antireflection film, thus possibly leading to defects that the film is deteriorated by an alkaline hydrolysis of the surface and that a smear may be formed by the eventually remaining saponifying solution. In such case, the method (2) is superior though it requires a particular process:

(1) After the antireflection layer is formed on the transparent substrate, the film is immersed at least once in an alkali solution whereby a rear surface of the film is saponified:

(2) Before or after the antireflection layer is formed on the transparent substrate, an alkali solution is coated on a surface of the optical film, opposite to a surface thereof bearing the optical layer, then heated, washed with water and/or neutralized whereby the film is saponified only on the rear surface thereof.

In the invention, following conditions are taken as standard saponification conditions, but a polarizing plate that is saponified in a generally continuous process and is formed into a polarizing plate in a polarizing plate manufacturing process is also defined as “ca polarizing plate having an antireflection film after saponification” of the present invention.

Standard Saponification Conditions

The antireflection film is processed and dried in the following steps:

(1) Alkali Bath

1.5 mol/L aqueous solution of sodium hydroxide

55° C., 120 seconds

(2) First Rinsing Bath

tap water, 60 seconds

(3) Neutralizing Bath

0.05 mol/L sulfuric

30° C., 20 seconds

(4) Second Rinsing Bath

tap water, 60 seconds

(5) Drying

120° C., 60 seconds

(Coated Film Forming Method)

The optical film of the invention can be prepared by a following method, but the present invention is not limited to such method.

At first a coating liquid containing components for forming each layer is prepared. The coating liquid is coated on a transparent substrate by a dip coating method, an air-knife coating method, a curtain coating method, a roller coating method, a dip coating method, a gravure coating method or an extrusion coating method (described in U.S. Pat. No. 2,681,294), and heat dried. Among these coating methods, a gravure coating method is preferable as it can coat a coating liquid of a small coating amount, such as each layer of the antireflection film, with a uniform thickness. Among the gravure coating method, a microgravure coating method provides a high uniformity in film thickness and is more preferred.

Also a die coating method can coat a coating liquid of a small coating amount with a high uniformity in thickness, and is preferred for a relatively easy film thickness control because of a pre-measurement method and for a limited evaporation of a solvent in the coating part. For coating a thin layer coating liquid of a wet film thickness of several tens of microns or less with a specified slot die or a specified coating method for example on a plastic film, there can be advantageously employed methods described in JP-A Nos. 2003-200097, 2003-211052, 2003-230862, 2003-236434, 2003-236451, 2003-245595, 2003-251260, 2003-260400, 2003-260402, 2003-275652, and 2004-141806. Two or more layers may be coated simultaneously. A simultaneous coating method is described for example in U.S. Pat. Nos. 2,761,791, 2,941,898, 3,508,947 and 3,526,528 and Yuji Harasaki, Coating Engineering, p. 253, published by Asakura Shoten (1973).

(Polarizing Plate)

A polarizing plate principally includes a polarizing film and two protective films sandwiching the same on both sides. The optical film of the invention is preferably employed in at least one of the two protective films sandwiching the polarizing film on both sides thereof. The optical film of the invention, employed as the protective film, allows to reduce the production cost of the polarizing plate. Also the optical film of the invention, employed in the outermost layer, can provide a polarizing plate capable of preventing a reflection of an external light and excellent in a scratch resistance and an antismear property.

As the polarizing film, there may be employed an already known polarizing film, or a polarizing film cut out from a web-shaped polarizing film of which an absorbing axis is not parallel nor perpendicular to the longitudinal direction. A web-shaped polarizing film of which an absorbing axis is not parallel nor perpendicular to the longitudinal direction can be prepared by a following method.

More specifically, it is a polarizing film formed by stretching a continuously supplied polymer film by giving a tension by holding both edge portions thereof with holding means, and can be produced by a stretching method of stretching the film by 1.1 to 20.0 times in at least a transversal direction of the film, in which a difference in the longitudinal advancing speed between the holding devices on both edges of the film is 3% or less and in which the advancing direction of the film is bent in a state, where the both edges of the film are supported, in such a manner that the film advancing direction at an exit of the step of supporting both edges of the film is inclined by 200 to 70° to the substantial stretching direction of the film. An inclination angle of 45° is employed advantageous in consideration of the productivity.

A stretching method for the polymer film is described in JP-A No. 2002-86554, paragraph 0020-0030.

(Image Display)

An image display of the invention is characterized in that an antireflection film of the invention or a polarizing plate, having an antireflection film, is provided on an image display plane. Thus, the antireflection film of the invention or the polarizing plate, having the antireflection film, can be applied to an image display such as a liquid crystal display apparatus (LCD) or an organic EL display. The image display of the invention is preferably applied to a transmission or reflective liquid crystal display apparatus of TN, STN, IPS, VA or OCB mode. In the following such apparatus will be explained further.

The liquid crystal display apparatus can be any of known types, such as those described for example in Tatsuo Uchida, “Reflective color LCD Technologies”, published by CMC Co., 1999, “New Developments of Flat Panel Display”, Toray Research Center, 1996, and “Ekisho Kanren Shio no Genjo to Shorai Tenbo (Vol. I and Vol. II)”, Fuji Kimera Soken Co., 2003.

More specifically, it can be advantageously employed in a transmissive, reflective or semi-reflective liquid crystal display apparatus of a twisted nematic mode (TN), a super twisted nematic mode (STN), a vertical alignment mode (VA), an in-plain switching mode (IPS), an optically compensatory bend mode (OCB).

The antireflection film of the invention shows, even in case the liquid crystal display apparatus has a displayed image of a size of 17 inches or larger, a satisfactory contrast, and a wide viewing angle and is capable of preventing a change in chromaticity and a reflection of the external light.

(TN Mode Liquid Crystal Display Apparatus)

A liquid crystal cell of TN mode is most frequently employed as a color TFT liquid crystal display apparatus, and is described in various literatures. In the TN mode, rod-shaped liquid crystal molecules assume, in a black display state, a standing alignment state in a central portion of the cell, and a lying alignment state in the vicinity of the substrates of the cell.

(OCB Mode Liquid Crystal Display Apparatus)

A liquid crystal cell of OCB mode adopts a bent alignment in which the rod-shaped liquid crystal molecules are aligned in substantially opposite directions (in symmetric manner) in upper and lower portions of the liquid crystal cell. In a liquid crystal display apparatus employing a liquid crystal cell of such bent alignment mode as described in U.S. Pat. Nos. 4,583,825 and 5,410,422, the liquid crystal cell of the bent alignment mode has an optical self-compensating function, because of alignments symmetrical in the upper and lower portions of the liquid crystal cell. For this reason, such liquid crystal mode is called an OCB (optically compensatory bend) mode.

In the OCB mode, as in the TN mode, rod-shaped liquid crystal molecules assume, in a black display state, a standing alignment state in a central portion of the cell, and a lying alignment state in the vicinity of the substrates of the cell.

(VA Mode Liquid Crystal Display Apparatus)

In a liquid crystal cell of VA mode, rod-shaped liquid crystal molecules are aligned substantially vertically in the absence of voltage application.

The liquid crystal cell of VA mode includes (1) a liquid crystal cell of VA mode of narrow sense in which the rod-shaped liquid crystal molecules are aligned substantially vertically in the absence of a voltage application and aligned substantially horizontally under a voltage application (described in JP-A No. 2-176625), (2) a liquid crystal cell (of MVA mode) in which the VA mode is formed in multi domains for expanding the viewing angle (SID97, Digest of tech. papers (preprints) 28 (1997), 845), (3) a liquid crystal cell of an n-ASM mode in which the rod-shaped liquid crystal molecules are aligned substantially vertically in the absence of a voltage application and are aligned in twisted multi domains under a voltage application (described in Japan Liquid Crystal Seminar, preprints 58-59 (1998)), and (4) a liquid crystal cell of a SURVAIVAL mode (reported at LCD International 98).

(IPS Mode Liquid Crystal Display Apparatus)

In a liquid crystal cell of IPS mode, the liquid crystal molecules are always rotated in a horizontal plane to the substrate, and are aligned with a certain angle to a longitudinal direction of electrodes in the absence of a voltage application but are shifted to a direction along an electric field, in the presence of a voltage application. An optical transmittance can be changed by positioning polarizing plates, sandwiching the liquid crystal cell, at specified angles. There are employed liquid crystal molecules of a nematic liquid crystal with a positive dielectric anisotropy Δ∈. A thickness (gap) of the liquid crystal layer is selected larger than 2.8 μm but smaller than 4.5 μm. Transmission characteristics with scarce wavelength dependence within the visible wavelength range can be obtained in case a retardation Δn·d is larger than 0.25 μm and smaller than 0.32 μm. A maximum transmittance can be obtained, by a combination of the polarizing plates, when the liquid crystal molecules are rotated by 45° from the rubbing direction toward the direction of the electric field. The thickness (gap) of the liquid crystal layer is controlled by polymer beads. A similar gap can naturally be obtained with glass beads, glass fibers, or resinous rod-shaped spacers. Also any nematic liquid crystal molecules may be employed without restriction. A dielectric anisotropy Δ∈ is preferably larger for reducing a driving voltage, and a refractive index anisotropy Δn is preferably smaller for increasing the thickness (gap) of the liquid crystal layer thereby reducing a liquid crystal pouring time and reducing a fluctuation in the gap.

(Other Liquid Crystal Modes)

The polarizing plate of the invention can be applied to a liquid crystal display apparatus of STN mode in a similar manner as explained above. Also it can be similarly applied to an apparatus of ECB mode.

Also the polarizing plate of the invention can be applied, in a combination with a λ/4 plate, in a polarizing plate of a reflective liquid crystal display or in a surface protective plate for an organic EL display, for reducing the light reflected from the surface and from the interior.

### EXAMPLES

In the following, the present invention will be further clarified by examples, but the present invention is not limited to such examples. In the following description, “part” and “%” are based on weight unless specified otherwise.

### Example 1

### Preparation Example 1

### Preparation of Inorganic Fine Particles (P-1)

360 g of tetraethoxysilane (TEOS, SiO₂ concentration 28 weight %) and 530 g of methanol were mixed, then the mixture was subjected, at 25° C., to respective dropwise additions of 100 g of ion exchanged water and an aqueous ammonia solution (containing 28% of ammonia), and ripened for 24 hours under agitation. Then the mixture was heated in an autoclave for 4 hours at 180° C., and subjected to a solvent replacement to ethanol utilizing an ultrafiltration membrane to obtain a dispersion liquid of inorganic fine particles (P-1) with a solid concentration of 20 weight %.

### Preparation Example 2

### Preparation of Inorganic Fine Particles (P-2)

A mixture of 100.0 g of the inorganic fine particle (P-1) dispersion liquid prepared in Preparation Example 1, 900 g of ion-exchanged water and 800 g of ethanol was heated to 30° C., then 360 g of tetraethoxysilane (SiO₂ concentration 28 weight %) and 626 g of a 28% ammonia solution were added to form a silica shell layer by a hydrolysis-polycondensate of tetraethoxysilane on the particle surface. The reaction mixture was concentrated in an evaporator to a solid concentration of 5 wt. %, then brought to a pH value 10 by an addition of an ammonia solution of a concentration of 15 weight %, then heated in an autoclave for 4 hours at 180° C., and subjected to a solvent replacement to ethanol utilizing an ultrafiltration membrane to obtain a dispersion liquid of inorganic fine particles (P-2) with a solid concentration of 20 weight %.

### Preparation Example 3

### Preparation of Inorganic Fine Particles (P-3)

Inorganic fine particles (P-5) were prepared in the same manner as the organic fine particles (P-2) except that an amount of tetraethoxysilane (SiO₂ concentration 28 weight %) was changed from 360 g to 470 g.

### Preparation Example 4

### Preparation of Inorganic Fine Particles (P-4)

90 g of silica sol of an average particle size of 5 nm and a SiO₂ concentration of 20 weight % and 1710 g of ion-exchanged water were mixed to prepare a reaction liquid, which was then heated to 95° C. The reaction liquid had a pH value of 10.5. 24,900 g of an aqueous solution of sodium silicate corresponding to 0.5 weight % as SiO₂ and 36,800 g of an aqueous solution of sodium aluminate corresponding to 0.5 weight % as Al₂O₃ were added at the same time. During the addition, the reaction liquid was maintained at 91° C. After the addition, the reaction liquid was cooled to the room temperature and rinsed, utilizing an ultrafiltration membrane to obtain a dispersion (A) of SiO₂.Al₂O₃ core particles with a solid concentration of 20 weight % (first preparation step).

Then 500 g of the core particle dispersion (A) were added with 1,700 g of ion-exchanged water, heated and maintained at 98° C., and 2,100 g of a silicic acid solution (SiO₂ concentration of 3.5 weight %), obtained by a dealkali reaction of an aqueous solution of sodium silicate with a cation exchange resin, were added to form a protective silica film on the surface of the core particles. The obtained dispersion of the core particles, having the protective silica film, was regulated to a solid concentration 13 weight %, by rinsing with an ultrafiltration membrane. Then, 1,125 g of ion-exchanged water were added to 500 g of the core particle dispersion, then the pH value was brought to 1.0 by dropwise adding concentrated hydrochloric acid (35.5%) to execute an aluminum-elimination process, and the dissolved aluminum salt was separated by an ultrafiltration membrane under additions of 10 L of an aqueous solution of hydrochloric acid of pH 3 and 5 L of ion-exchanged water, thereby obtaining a dispersion of particle precursors (second preparation step).

Then a mixture of 1500 g of the particle precursor dispersion, 500 g of ion-exchanged water and 1,750 g of ethanol was heated at 30° C., and 40 g of tetraethoxysilane (SiO₂ 28 weight %) and 626 g of a 28% ammonia solution were added under a rate control to form a silica shell layer of a hydrolysis-polycondensate of tetraethoxysilane on the surface of the particle precursors, thereby obtaining particles having internal pores. The reaction mixture was concentrated in an evaporator to a solid concentration of 5 wt. %, then brought to a pH value 10 by an addition of an ammonia solution of a concentration of 15 weight %, then heated in an autoclave for 4 hours at 180° C., and subjected to a solvent replacement to ethanol utilizing an ultrafiltration membrane to obtain a dispersion liquid of hollow silica fine particle sol (pore-containing inorganic fine particles) (P-4) with a solid concentration of 20 weight % (third preparation step).

### Preparation Example 5

### Preparation of Inorganic Fine Particles (P-5)

A hollow silica fine particle sol (P-5) was prepared in the same manner as the preparation of the inorganic fine particles (P-4), except that, in the third preparation step for the inorganic fine particles (P-4), the amount of tetraethoxysilane (SiO₂ 28 weight %) was changed to 60 g.

### Preparation Example 6

### Preparation of Inorganic Oxide Fine Particles (P-6)

A hollow silica fine particle sol (P-6) was prepared in the same manner as the preparation of the inorganic fine particles (P-4), except that, in the third preparation step for the inorganic fine particles (P-4), the amount of tetraethoxysilane (SiO₂ 28 weight %) was changed to 70 g.

### Preparation Example 7

### Preparation of Inorganic Fine Particles (P-7)

A hollow silica fine particle sol (P-7) was prepared in the same manner as the preparation of the inorganic fine particles (P-4), except that, in the third preparation step for the inorganic fine particles (P-4), the amount of tetraethoxysilane (SiO₂ 28 weight %) was changed to 160 g.

### Preparation Example 8

### Preparation of Inorganic Oxide Fine Particles (P-8)

As a comparative example of non-porous silica particles, a commercially available dispersion of silica particles with an average particle size of 50 nm (IPA-ST-L, manufactured by Nissan Chemical Co., silica solid content: 30 weight %, solvent: isopropyl alcohol) was diluted with isopropyl alcohol so as to obtain a silica solid concentration of 20 weight %.

(Evaluation of Inorganic Fine Particles)

The particles thus obtained were subjected to following evaluations.

(Evaluation 1): Particle Size Measurement

The dispersion liquid was diluted, scooped on a grid and observed under a transmission electron microscope, and an average particle size was determined on 1,000 particles.

(Evaluation 2): Adsorbed Water Amount

The dispersion liquid was dried in an evaporator to a powder state, and an adsorbed water amount was calculated as a weight decrease rate when heated to 200° C., according to a following equation:
adsorbed water amount(%)=100×(W20−W200)/W200
(W20: initial weight at the start of temperature elevation, W200: weight when heated to 200° C.).

(Evaluation 3): Refractive Index of Particle

Coated films were prepared with different contents of the particles in the matrix, in a method as described in the foregoing text. Refractive indexes of the films were measured and were extrapolated to a refractive index with a content of the inorganic fine particles of 100%.

Results of the evaluations (1)-(3) are shown in Table 1, together with results when the particles were incorporated in antireflection films.

### Example 2

A multi-layered antireflection film was prepared in the following manner.

(Preparation of Sol-Liquid a)

In a reactor equipped with an agitator and a reflux condenser, 120 parts of methyl ethyl ketone, 100 parts of acryloyloxypropyl trimethoxysilane (KBM-5103, manufactured by Shin-Etsu Chemical Co.) and 3 parts of diisopropoxyaluminum ethyl acetoacetate (trade name: Chelope EP-12, manufactured by Hope Pharmaceutical Co.) were mixed, then 30 parts of ion-exchanged water were added and the mixture was reacted for 4 hours at 60° C. and cooled to the room temperature to prepare a sol liquid a. It had a weight-averaged molecular weight of 1,600, and, among components equal to or larger than oligomers, components with a molecular weight of 1,000 to 20,000 represented 100%. Also a gas chromatography analysis indicated that the acryloyloxypropyl trimethoxysilane employed as the raw material did not remain at all. Then the sol liquid a was obtained by adding methyl ethyl ketone so as to obtain a solid concentration of 29%.

(Preparation of Dispersion Liquid A-6)

500 parts of hollow silica fine particles (silica concentration: 20 weight %, dispersion in ethanol) prepared in Preparation Example 6 were subjected to a solvent replacement by a reduced-pressure distillation under a pressure of 20 kPa, under an addition of isopropyl alcohol so as to maintain a substantially constant silica content. 500 parts of thus obtained silica dispersion (silica concentration: 20%) were mixed with 30 parts of acryloyloxypropyl trimethoxysilane (KBM-5103, manufactured by Shin-Etsu Chemical Co.) and 1.5 parts of diisopropoxyaluminum ethyl acetoacetate (trade name: Chelope EP-12, manufactured by Hope Pharmaceutical Co.), then 9 parts of ion-exchanged water were added. After a reaction for 8 hours at 60° C. and the mixture was cooled to the room temperature and 1.8 parts of acetylacetone were added. 500 g of the dispersion were subjected to a solvent replacement by a reduced-pressure distillation at a pressure of 20 kPa, under an addition of cyclohexanone so as to maintain a substantially constant silica content. The dispersion did not show formation of extraneous substances, and had a viscosity at 25° C. of 5 mPa·s when the solid concentration was regulated to 20 weight % with cyclohexanone. A gas chromatography analysis on the obtained dispersion (A-6) indicated a remaining amount of isopropyl alcohol of 1.5%.

Other inorganic fine particles (P-1) to (P-5), (P-7) and (P-8) prepared in Example 1 were similarly processed as in the preparation of the dispersion (A-6) to obtain respectively corresponding dispersion liquids (A-1) to (A-5), (A-7) and (A-8).

(Preparation of Dispersion B-6)

To 500 parts of the hollow silica particle sol (P-6) prepared in the preparation example 6 (silica concentration: 20 mass %, dispersion in ethanol), 60.0 g of methyl ethyl ketone and 10.0 g of hexamethylsiloxane were added and agitated, and the mixture was ripened by a standing for 7 days at 25° C. to obtain a silylated silica sol. The dispersion was subjected to a solvent replacement by a distillation under a reduced pressure of 20 kPa, under addition of cyclohexanone so as to maintain a substantially constant silica content. The dispersion did not show generation of extraneous matter, and had a viscosity of 4.5 mPa·s at 25° C. when the solid concentration was regulated with cyclohexanone to 20 mass %.

Also other inorganic particles (P-1) to (P-5), (P-7) and (P-8) prepared in Example 1 were processed in a similar manner as the preparation of the dispersion (B-6) to obtain corresponding dispersions (B-1) to (B-5), (B-7) and (B-8).

(Preparation of Low Refractive Index Layer Coating Liquid (L-1))

A coating liquid L-1 was prepared by diluting Opstar JTA113 (thermocrosslinkable fluorine-containing silicone polymer composition (solid 6%), manufactured by JSR Corp.) with cyclohexane and methyl ethyl ketone in such a manner that the entire coating liquid had a solid concentration of 5 weight % and that cyclohexane and methyl ethyl ketone had a ratio 10:90.

(Preparation of Low Refractive Index Layer Coating Liquid (L-2))

To 933.3 parts by weight (corresponding to 56.0 parts by weight of solids) of Opstar JTA113 (thermocrosslinkable fluorine-containing silicone polymer composition (solid 6%), manufactured by JSR Corp.), 195 parts by weight of the dispersion liquid (A-1) (silica and solid of surface treating agent representing 39.0 parts by weight) and 17.2 parts by weight (corresponding to 5.0 parts by weight of solids) of the sol liquid a were added. A coating liquid (L-2) was prepared by diluting the mixture with cyclohexane and methyl ethyl ketone in such a manner that the entire coating liquid had a solid concentration of 6 weight % and that cyclohexane and methyl ethyl ketone had a ratio 10:90.

(Preparation of Low Refractive Index Layer Coating Liquids (L-3)-(L-9))

Coating liquids (L-3)-(L-9) were prepared in the same manner as (L-2) except that the dispersion liquid (A-1) in the low refractive index layer coating liquid (L-2) was respectively replaced by dispersion liquids (A-2)-(A-3).

(Preparation of Hard Coat Layer Coating Liquid A)

100 parts by weight of Desolite Z7404 (hard coat composition containing zirconia fine particles, manufactured by JSR Corp.), 31 parts by weight of DPHA (UV curable resin, manufactured by Nippon Kayaku Co.), 10 parts by weight of KBM-5103 (silane coupling agent, manufactured by Shin-etsu Chemical Co.), 29 parts by weight of methyl ethyl ketone, 13 parts by weight of methyl isobutyl ketone and 5 parts by weight of cyclohexanone were charged and agitated in a mixing tank to obtain a hard coat layer coating liquid A.

(Preparation of Antireflection Film (201))

A triacetyl cellulose film of a thickness of 80 μm (TAC-TD80U, manufactured by Fuji Photo Film Co., Ltd.) in a roll form was unwound as a substrate and coated with the hard coat layer coating liquid A, utilizing a microgravure roll of a diameter of 50 mm having a gravure pattern of lines of 135 line/inch and a depth of 60 μm and a doctor blade, under a transporting speed of 10 m/min, then dried for 150 seconds at 60° C., and irradiated with an ultraviolet light of an illumination intensity of 400 mW/cm² and an illumination amount of 100 mJ/cm² utilizing an air-cooled metal halide lamp of 160 W/cm (manufactured by Eyegraphics Co.) under nitrogen purging to cure the coated layer, thereby obtaining a hard coat layer and the film was thereafter wound again. A hard coat film 201 was prepared by regulating a revolution of the gravure roll so as to obtain a hard coat layer of a thickness after curing of 4.0 μm.

On thus prepared hard coat film 201, the coating liquid (L-1) for the low refractive index layer was so coated as to obtain a thickness of 90 nm in the low refractive index layer, thereby obtaining an antireflection film 201. The low refractive index layer was dried under conditions of 12 minutes, 120° C., and the UV curing was conducted with an ultraviolet irradiation of an illumination intensity of 120 mW/cm² and an illumination amount of 240 mJ/cm² utilizing an air-cooled metal halide lamp of 240 W/cm (manufactured by Eyegraphics Co.) under nitrogen purging to obtain an atmosphere with an oxygen concentration of 0.01 vol. % or less. The low refractive index layer after curing had a refractive index of 1.45.

(Preparation of Antireflection Films (202) to (209))

Antireflection films (202) to (209) were prepared in the same manner as the antireflection film (201) except that the low refractive index layer coating liquid (L-1) employed therein was replaced respectively by (L-2) to (L-9).

(Saponification Treatment of Antireflective Film)

The obtained antireflective film was treated and dried under following standard saponification conditions:

(1) Alkali Bath

1.5 mol/L aqueous solution of sodium hydroxide

55° C., 120 seconds

(2) First Rinsing Bath

tap water, 60 seconds

(3) Neutralizing Bath

0.05 mol/L sulfuric

30° C., 20 seconds

(4) Second Rinsing Bath

tap water, 60 seconds

(5) Drying

120° C., 60 seconds

(Evaluation of Antireflection Film)

The antireflection film thus obtained after saponification was subjected to following evaluations.

(Evaluation 4): Measurement of Average Reflectance

A spectral reflectance at an incident angle of 5° within a wavelength range of 380-780 nm was measured with a spectrophotometer V-550 (manufactured by Jaco Corp.) and with an integrating sphere. In the evaluation of the spectral reflectance, an average reflectance in a wavelength range of 450 to 650 nm was employed.

A sample prepared as a polarizing plate was evaluated in the form of such polarizing plate, while, in a film itself or a display apparatus not employing a polarizing plate, a rear surface of the antireflection film was subjected to a light absorbing treatment with a black ink (transmittance of less than 10% at 380 to 780 nm) and a measurement was made on a black table.

(Evaluation 5): Measurement of ΔE in Trace of Water Attaching

An outermost surface of a film, a polarizing plate or an antireflection film of an image display was placed horizontally. After it was let to stand for 30 minutes or longer in a condition of 25° C. and 55% RH, 2.0 ml of ion-exchanged water were dropped over about 2 seconds with a pipette (manufactured by Eppendorf AG). The water drop was spread to a circular shape of a diameter of about 1.5 to 2.5 cm, though an ease of spreading varies depending on a surface property of the antireflection film. After a standing for 15 minutes, the water drop was wiped off with Bemcot (manufactured by Asahi Kasei Corp.). A reflective spectrum of the antireflection film was measured before and after the dropping of the water drop. The measurement was conducted with a UV/Vis Spectrophotometer Model V-550 manufactured by JASCO Inc. and a chromaticity change (ΔE) in a CIE1976 L*a*b* color space under a standard light source D65 was determined.

(Evaluation 6): Evaluation of Wiping Property of Solvent Marker Ink

A circle of a diameter of 1 cm was drawn and painted solid with a solver marker Magic Ink No. 700, ultra fine (manufactured by Teranishi Kagaku Kogyo Co.). The sample was at first dried for 30 minutes at 25° C., 55% RH, then let to stand for 24 hours under conditions of 40° C., 80% RH, then let to stand for 30 minutes or longer under conditions of 25° C., 55% RH and rubbed with Bemcot (manufactured by Asahi Kasei Corp.), and evaluation was made as to whether the marker ink could be wiped off.
A: no trace of marker ink observable even under very careful observation;
AB: trace of marker ink slightly observable;
BC: unerasable trace detectable;
C: marker ink hardly removable.

Results of evaluation are shown in Table 1.

TABLE 1

| | | | | | antireflection film | | | | |
|---|---|---|---|---|---|---|---|---|---|
| | oxide fine particles | | | | | | trace of | | |
| Anti- | | particle | adsorbed | | refractive index | average | attached | | |
| reflection | | size | water | refractive | of low refractive | reflectance | water drop | marker ink | |
| film | particles | (nm) | amount (%) | index | index layer | (%) | (ΔE) | wiping property | remarks |
| 201 | — | — | — | — | 1.45 | 2.03 | 0.05 | A | comp. ex |
| 202 | (P-1) | 40 | 7.8 | 1.18 | 1.32 | 1.01 | 2.80 | C | comp. ex |
| 203 | (P-2) | 50 | 6.1 | 1.30 | 1.38 | 1.30 | 0.45 | AB | inventn |
| 204 | (P-3) | 55 | 5.7 | 1.35 | 1.40 | 1.51 | 0.20 | AB | inventn |
| 205 | (P-4) | 50 | 7.1 | 1.22 | 1.34 | 1.06 | 2.10 | AB | comp. ex |
| 206 | (P-5) | 50 | 6.3 | 1.27 | 1.36 | 1.13 | 1.65 | A | comp. ex |
| 207 | (P-6) | 51 | 6.1 | 1.28 | 1.37 | 1.18 | 0.35 | A | inventn |
| 208 | (P-7) | 52 | 5.3 | 1.30 | 1.38 | 1.30 | 0.05 | A | inventn |
| 209 | (P-8) | 50 | 1.1 | 1.46 | 1.45 | 2.05 | 0.05 | A | comp. ex |

Results shown in Table 1 indicate followings. Oxide particles of the invention with a lower adsorption water amount achieves an improvement on the trace of attached water drop on the antireflection film. Also for a same refractive index of the particles, hollow particles are superior to porous particles in the trace of the attached water drop and the marker ink wiping property (comparison of antireflection films (203) and (208)).

Also an evaluation similar to that in Example 2 employing a following low refractive index coating liquid (L-7B) clarified that the present invention can provide an antireflection film having a low refractive index, little trace of water drop deposition and an excellent wipe-off property for a solvent marker.

(Preparation of Low Refractive Index Coating Liquid (L-7B))

44.5 g of a thermally crosslinkable fluorine-containing polymer (thermally crosslinkable fluorine-containing polymer described in JP-A No. 11-189621, Example 1) were dissolved in 100.0 g of methyl ethyl ketone, and there were added 11.5 g of a curing agent (Scimel 303 (trade name), manufactured by Nippon Cytec Industries Ltd.), 1.1 g of a curing catalyst (Catalyst 4050 (trade name), manufactured by Nippon Cytec Industries Ltd.), 165 parts by mass of the dispersion (B-6) (containing 33 parts by mass of silica and surface modifying agent in solids), and 37.8 parts by mass of the sol liquid a (containing 11.0 parts by mass in solid). A coating liquid (L-7B) was prepared by diluting with cyclohexane and methyl ethyl ketone in such a manner that the solid concentration in the entire coating liquid became 6 mass % and cyclohexane and methyl ethyl ketone had a ratio 10:90.

### Example 3

### Preparation of Low Refractive Index Layer Coating Liquid (L-10)

To 70 parts by weight of methyl ethyl ketone, 30.0 parts by weight of a fluorine-containing copolymer P-3 (weight-averaged molecular weight of about 50,000) described in JP-A No. 2004-45462, 1.5 parts by weight of a terminal methacrylate group-containing silicone RMS-033 (manufactured by Gelest Inc.), and 1.5 parts by weight of a photopolymerization initiator Irgacure 907 (manufactured by Ciba-Geigy Specialty Chemicals Inc.) were added and dissolved. A coating liquid (L-10) was prepared by diluting the mixture with cyclohexane and methyl ethyl ketone in such a manner that the entire coating liquid had a solid concentration of 5 weight % and that cyclohexane and methyl ethyl ketone had a ratio 10:90.

(Preparation of Low Refractive Index Layer Coating Liquid (L-11))

To 100 parts by weight of methyl ethyl ketone, 47.0 parts by weight of a fluorine-containing copolymer P-3 (weight-averaged molecular weight of about 50,000) described in JP-A No. 2004-45462, 4.5 parts by weight of a terminal methacrylate group-containing silicone RMS-033 (manufactured by Gelest Inc.), and 4.5 parts by weight of a photopolymerization initiator Irgacure 907 (manufactured by Ciba-Geigy Specialty Chemicals Inc.) were added and dissolved. 195 parts by weight of the dispersion liquid (A-6) (silica and solid of surface treating agent representing 39.0 parts by weight) employed in Example 2 and 17.2 parts by weight (corresponding to 5.0 parts by weight of solids) of the sol liquid a were added. A coating liquid (L-11) was prepared by diluting the mixture with cyclohexane and methyl ethyl ketone in such a manner that the entire coating liquid had a solid concentration of 6 weight % and that cyclohexane and methyl ethyl ketone had a ratio 10:90.

(Preparation of Low Refractive Index Layer Coating Liquid (L-12))

Tetraethoxysilane by 95 mol. % and C₃F₇—(OC₃F₆)₂₄—O—(CF₂)₂—C₂H₄—O—CH₂Si(OCH₃)₃ by 5 mol. % were mixed, utilizing 1.0 mol/L hydrochloric acid as a catalyst to prepare a low refractive index layer coating liquid (solid concentration: 6 weight %, main solvent: 20:80 weight ratio mixture of ethyl alcohol and isopropyl alcohol).

(Preparation of Low Refractive Index Layer Coating Liquid (L-13))

Tetraethoxysilane by 95 mol. % and C₃F₇—(OC₃F₆)₂₄—O—(CF₂)₂—C₂H₄—O—CH₂Si(OCH₃)₃ by 5 mol. % were mixed, utilizing 1.0 mol/L hydrochloric acid as a catalyst to prepare a low refractive index layer coating liquid (solid concentration: 6 weight %, main solvent: 20:80 weight ratio mixture of ethyl alcohol and isopropyl alcohol). To 100 g of the liquid (solid 6.0 g), 30.0 g (solid 6.0 g) of the hollow silica fine particles sol (P-6) prepared in Example 1 were added and the mixture was diluted with isopropyl alcohol so as to obtain a solid concentration of the entire coating liquid of 6 weight %.

(Preparation of Low Refractive Index Layer Coating Liquid (L-14))

To 100 parts by weight of methyl ethyl ketone, 30.0 parts by weight of a mixture of dipentaerythritol pentaacrylate and dipentaerythritol hexaacrylate (DPHA, manufactured by Nippon Kayaku Co.), 1.5 parts by weight of a terminal methacrylate group-containing silicone RIMS-033 (manufactured by Gelest Inc.), and 1.5 parts by weight of a photopolymerization initiator Irgacure 907 (manufactured by Ciba-Geigy Specialty Chemicals Inc.) were added and dissolved. A coating liquid L-14) was prepared by diluting the mixture with cyclohexane and methyl ethyl ketone in such a manner that the entire coating liquid had a solid concentration of 5 weight % and that cyclohexane and methyl ethyl ketone had a ratio 10:90.

(Preparation of Low Refractive Index Layer Coating Liquid (L-15))

To 100 parts by weight of methyl ethyl ketone, 47.0 parts by weight of a mixture of dipentaerythritol pentaacrylate and dipentaerythritol hexaacrylate (DPHA, manufactured by Nippon Kayaku Co.), 4.5 parts by weight of a terminal methacrylate group-containing silicone RMS-033 (manufactured by Gelest Inc.), and 4.5 parts by weight of a photopolymerization initiator Irgacure 907 (manufactured by Ciba Specialty Chemicals Inc.) were added and dissolved. 195 parts by weight of the dispersion liquid (A-6) (silica and solid of surface treating agent representing 39.0 parts by weight) employed in Example 2 and 17.2 parts by weight (corresponding to 5.0 parts by weight of solids) of the sol liquid a were added. A coating liquid (L-15) was prepared by diluting the mixture with cyclohexane and methyl ethyl ketone in such a manner that the entire coating liquid had a solid concentration of 6 weight % and that cyclohexane and methyl ethyl ketone had a ratio 10:90.

(Preparation of Antireflection Films (301) to (308))

On the hard coat film 201 prepared in Example 2, coating liquids (L-1), (L-7) and (L-10) to (L-15) were coated and cured in a similar manner as in the antireflection film (201) in Example 2.

These antireflection films were saponified and dried in the process described in Example 2. Evaluations were conducted in a similar manner as in Example 2, utilizing both unsaponified samples and saponified samples. Results are shown in Table 2.

TABLE 2

| | | antireflection film | | | | | |
|---|---|---|---|---|---|---|---|
| anti- | | low refractive | refractive index | average | trace of | | |
| reflection | fine | index layer | of low refractive | reflectance | attached | marker ink | |
| film No. | particles | coating liquid | index layer | (%) | water drop | wiping property | remarks |
| 301 before sapo. | — | L-1 | 1.45 | 2.03 | 0.05 | A | comp. ex. |
| 302 before sapo. | (P-6) | L-7 | 1.37 | 1.18 | 0.05 | A | invention |
| 303 before sapo. | — | L-10 | 1.44 | 2.01 | 0.05 | A | comp. ex. |
| 304 before sapo. | (P-6) | L-11 | 1.36 | 1.16 | 0.05 | AB | invention |
| 305 before sapo. | — | L-12 | 1.44 | 2.01 | 0.15 | A | comp. ex. |
| 306 before sapo. | (P-6) | L-13 | 1.36 | 1.16 | 0.15 | AB | invention |
| 307 before sapo. | — | L-14 | 1.52 | 3.10 | 0.05 | A | comp. ex. |
| 308 before sapo. | (P-6) | L-15 | 1.48 | 2.20 | 0.05 | AB | invention |
| 301 after sapo. | — | L-1 | 1.45 | 2.03 | 0.05 | A | comp. ex. |
| 302 after sapo. | (P-6) | L-7 | 1.37 | 1.18 | 0.35 | A | invention |
| 303 after sapo. | — | L-10 | 1.44 | 2.01 | 0.05 | A | comp. ex. |
| 304 after sapo. | (P-6) | L-11 | 1.36 | 1.16 | 0.35 | AB | invention |
| 305 after sapo. | — | L-12 | 1.44 | 2.01 | *1) | *1) | comp. ex. |
| 306 after sapo. | (P-6) | L-13 | 1.36 | 1.16 | *1) | *1) | ref. ex. |
| 307 after sapo. | — | L-14 | 1.52 | 3.10 | 0.05 | A | comp. ex. |
| 308 after sapo. | (P-6) | L-15 | 1.48 | 2.20 | 0.45 | AB | invention |

*1) In antireflection films 305 and 306, the low refractive index layer was broken by saponification.
Coating liquids L-7, L-11 and L-15, employed dispersion (A-6), and L-13 employed hollow silica fine particle sol (P-6).

Results shown in Table 2 indicate followings. A saponified sample was inferior to an unsaponified sample in the trace of attached water drop and in the marker ink wiping property. Particularly in the samples of the antireflection films (305) and (306), utilizing only the binder prepared by hydrolysis of organosilane, the low refractive index layer was destructed by saponification. An antireflection film, utilizing a polymer having both a fluorinated alkyl group and a dimethylsiloxane portion in the main body of the polymer, shows a reduced trace of attached water drop even after saponification (comparison of antireflection films (302), (304) and (308)).

Also low refractive index coating liquids were prepared by changing, in the low refractive index coating liquids (L-10), (L-11), (L-14) and (L-15), the photoradical generator from Irgacure 907 (molecular weight 279) to Irgacure 369 (molecular weight 367) and Irgacure OXE01 (molecular weight 451) (both manufactured by Ciba Specialty Chemicals Inc.) of a same mass, and were evaluated in the same manner. As a result, it was clarified that an increase in the molecular weight of the photoradical generator improves trace of water drop deposition and a wipe-off property for a solvent marker, after the saponification.

### Example 4

### Preparation of Inorganic Oxide Fine Particles and Incorporation into Antireflection Film

In the preparation of the inorganic oxide particles (P-4) in Example 1, particles different in the particle size, the water adsorption amount and the refractive index were prepared by regulating following steps.

(Change in Particle Size)

In the first preparation step, the particle size was changed by regulating an amount of addition of the silica sol of an average particle size of 5 nm.

(Change in Adsorbed Water Amount)

Particles were prepared by regulating, in the second preparation step, an amount of the silicic acid solution (SiO₂ concentration: 3.5 weight %), or, by controlling, in the third preparation step, an amount of tetraethoxysilane, an amount of ammonia, a timing of addition, a temperature and a reaction time.

The inorganic oxide fine particles thus prepared were subjected to a solvent replacement and a surface treatment as in the preparation of the dispersion liquid (A-6) in Example 2, and antireflection films (401)-(417) were prepared in the same manner as the antireflection film (205) except for the difference in the inorganic oxide fine particles. Each sample was subjected to a saponification process as in Example 2, and to evaluations as in Examples 1 and 2. Results of evaluation are shown in Table 3.

TABLE 3

| | | | | antireflection film | | | |
|---|---|---|---|---|---|---|---|
| | oxide fine particles | | | | | trace of | |
| anti- | particle | adsorbed | | refractive index | | attached | |
| reflection | size | water | refractive | of low refractive | average | water drop | |
| film | (nm) | amount (%) | index | index layer | reflectance (%) | (ΔE) | remarks |
| 401 | 30 | 7.9 | 1.30 | 1.38 | 1.30 | 2.90 | comp. ex. |
| 402 | 31 | 6.0 | 1.35 | 1.40 | 1.51 | 0.35 | invention |
| 403 | 40 | 6.3 | 1.30 | 1.38 | 1.30 | 1.65 | comp. ex. |
| 404 | 41 | 5.5 | 1.32 | 1.39 | 1.37 | 0.08 | invention |
| 405 | 41 | 5.0 | 1.35 | 1.40 | 1.51 | 0.05 | invention |
| 406 | 50 | 6.3 | 1.27 | 1.36 | 1.13 | 1.65 | comp. ex. |
| 407 | 51 | 6.1 | 1.28 | 1.37 | 1.18 | 0.35 | invention |
| 408 | 52 | 5.3 | 1.30 | 1.38 | 1.30 | 0.05 | invention |
| 409 | 64 | 6.5 | 1.15 | 1.31 | 0.99 | 1.75 | comp. ex. |
| 410 | 65 | 6.0 | 1.19 | 1.33 | 1.02 | 0.35 | invention |
| 411 | 65 | 5.5 | 1.24 | 1.34 | 1.07 | 0.08 | invention |
| 412 | 66 | 4.0 | 1.30 | 1.38 | 1.30 | 0.05 | invention |
| 413 | 74 | 6.5 | 1.13 | 1.30 | 0.98 | 1.75 | comp. ex. |
| 414 | 75 | 5.9 | 1.17 | 1.31 | 1.00 | 0.30 | invention |
| 415 | 75 | 5.5 | 1.19 | 1.33 | 1.02 | 0.08 | invention |
| 416 | 76 | 5.0 | 1.24 | 1.34 | 1.07 | 0.05 | invention |
| 417 | 76 | 3.5 | 1.30 | 1.38 | 1.30 | 0.05 | invention |

Results in Table 3 indicate that an increase in the particle size can reduce the refractive index even in inorganic oxide particles with a low adsorption water amount and can reduce the reflectance of the film.

### Example 5

A multi-layered antireflection film was prepared in the following manner.

(Preparation of hard coat layer coating liquid B)

| | |
|---|---|
| PET-30 | 50.0 g |
| Irgacure 184 | 2.0 g |
| SX-350 (30%) | 1.5 g |
| crosslinked acryl-styrene particles (30%) | 13.9 g |
| FP-132 | 0.75 g |
| KBM-5103 | 10.0 g |
| toluene | 38.5 g |

The above-mentioned mixture was filtered with a polypropylene filter of a pore size of 30 μm to obtain a hard coat layer coating liquid B.

Respective employed compounds are shown in the following:

PET-30: a mixture of pentaerythritol triacrylate and pentaerythritol tetraacrylate (manufactured by Nippon Kayaku Co.);

Irgacure 184: a polymerization initiator (manufactured by Ciba Specialty Chemicals Inc.);

SX-350: crosslinked polystyrene particles of an average particle size of 3.5 μm (refractive index: 1.60, manufactured by Soken Chemical and Engineering Co., 30% dispersion in toluene, employed after a dispersion for 20 minutes at 10,000 rpm with a Polytron disperser);

Crosslinked acryl-styrene particles: average particle size 3.5 μm (refractive index: 1.55, manufactured by Soken Chemical and Engineering Co., 30% dispersion in toluene, employed after a dispersion for 20 minutes at 10,000 rpm with a Polytron disperser);

FP-132: fluorinated surface modifying agent;

(chem 11)

KBM-5103: acryloyloxypropyl trimethoxysilane (manufactured by Shin-etsu Chemical Co.).

(Coating of Hard Coat Layer)

A triacetyl cellulose film of a thickness of 80 μm (TAC-TD80U, manufactured by Fuji Photo Film Co., Ltd.) in a roll form was unwound and coated with the hard coat layer coating liquid B, utilizing a microgravure roll of a diameter of 50 mm having a gravure pattern of lines of 180 line/inch and a depth of 40 μm and a doctor blade, under conditions of a gravure roll revolution of 30 rpm and a transporting speed of 30 m/min, then dried for 150 seconds at 60° C., and irradiated with an ultraviolet light of an illumination intensity of 400 mW/cm² and an illumination amount of 110 mJ/cm² utilizing an air-cooled metal halide lamp of 160 W/cm (manufactured by Eyegraphics Co.) under an oxygen concentration of 0.1% with nitrogen purging to cure the coated layer, thereby forming a layer of a thickness of 6 μm. The film was thereafter wound again. The hard coat film 501 thus prepared had surface roughness of Ra=0.18 μm and Rz=1.40 μm, and a haze of 35%.

The hard coat film 501 was coated thereon with the low refractive index layer of Examples 2, 3 and 4, and subjected to an evaluation as in Example 2. As a result, it was confirmed that an antireflection film with a reduced trace of attached water drop and a low reflectance could be obtained according to the invention.

### Example 6

### Preparation of Polarizing Plate with Antireflection Film

A polarizing film was prepared by adsorbing iodine on a stretched polyvinyl alcohol film. A saponified antireflection film of Example 2 of the invention was adhered with a polyvinyl alcohol-based adhesive onto a side of the polarizing film in such a manner that the substrate (triacetyl cellulose) of the antireflection film was positioned at the side of the polarizing film. A viewing angle expanding film having an optical compensation layer (Wide View film SA12B, manufactured by Fuji Photo Film Co.) was saponified and adhered, with a polyvinyl alcohol-based adhesive, onto the other side of the polarizing film, thereby obtaining a polarizing plate. An evaluation as in Example 2 on such polarizing plate indicates that the antireflection film containing porous or hollow inorganic fine particles with a reduced adsorbed water content according to the invention provides a low reflectance and an improvement on the trace of attached water drop.

### Example 7

Each of samples of Examples 2-5 was adhered, with an adhesive material, onto a surface glass plate of an organic EL display apparatus, thereby providing a display of a high visibility with a reduced reflection on the glass surface. It was also confirmed that an improvement on a trace of attached water drop was attained in the sample containing porous or hollow inorganic fine particles with a reduced adsorbed water content.

It will be apparent to those skilled in the art that various modifications and variations can be made to the described preferred embodiments of the invention without departing from the spirit or scope of the invention. Thus, it is intended that the present invention cover all modifications and variations of this invention consistent with the scope of the appended claims and their equivalents.

This application is based on Japanese Patent Application No. JP2004-235198 filed on Aug. 12, 2004, the contents of which is incorporated herein by reference.

### INDUSTRIAL APPLICABILITY

An antireflection film according to the invention can be applied to a polarizing plate and an image display such as a liquid crystal display apparatus (LCD) or an organic EL display.

1. An antireflection film comprising at least one layer comprising fine pores, wherein when a surface portion of the antireflection film comes into contact with water for 15 minutes and then the water is wiped away, the surface portion has a chromaticity change ΔE of 0.45 or less, the chromaticity change ΔE being a chromaticity change in a CIE1976 L*a*b* color space and measured under a standard light source D65.

2. An antireflection film comprising at least one low refractive index layer having a refractive index of 1.40 or less, wherein when a surface portion of the antireflection film comes into contact with water for 15 minutes and then the water is wiped away, the surface portion has a chromaticity change ΔE of 0.45 or less, the chromaticity change ΔE being a chromaticity change in a CIE1976 L*a*b* color space and measured under a standard light source D65.

3. An antireflection film according to claim 1, which is subjected to an alkali saponification process.

4. An antireflection film according to claim 1, wherein the at least one layer comprises inorganic fine particles having at least one of a porous structure and a hollow structure.

5. An antireflection film according to claim 4, wherein the inorganic fine particles have an adsorbed water amount of 6.1 weight % or less and have a particle size of 20 to 100 nm.

6. (canceled)

7. An antireflection film according to claim 4 wherein the inorganic fine particles are hollow silica fine particles, and the hollow silica fine particles have a refractive index of 1.40 or less.

8. An antireflection film according to claim 7, wherein the hollow silica fine particles have a particle size of 45 to 80 nm and a refractive index of 1.30 or less.

9. A polarizing plate comprising: a polarizer; and a protective film, wherein the protective film comprises an antireflection film according to claim 1.

10. An image display comprising at least one of an antireflection film according to claim 1.

11. An antireflection film according to claim 2 which is subjected to an alkali saponification process.

12. An antireflection film according to claim 2, wherein the lower layer comprises inorganic fine particles having at least one of a porous structure and a hollow structure.

13. An antireflection film according to claim 12, wherein the inorganic fine particles have an adsorbed water amount of 6.1 weight % or less and have a particle size of 20 to 100 nm.

14. An antireflection film according to claim 2, wherein the low refractive index layer comprises a component having one of the fluorinated alkyl portion and a dialkylsiloxane portion.

15. An antireflection film according to claim 12 wherein the inorganic fine particles are hollow silica fine particles, and the hollow silica fine particles have a refractive index of 1.40 or less.

16. An antireflection film according to claim 15, wherein the hollow silica fine particles have a particle size of 45 to 80 nm and a refractive index of 1.30 or less.

17. A polarizing plate comprising a polarizer; and a protective film, wherein the protective film comprises and antireflection film according to claim 2.

18. An image display comprising at an antireflection film according to claim 2.
